(19) United States
(12) Patent Application Publication
(10) Pub. No.: US 2025/0300704 A1
(43) Pub. Date: Sep. 25, 2025

(54) METHOD AND APPARATUS FOR DYNAMIC PRECODER DETERMINATION IN A WIRELESS COMMUNICATION SYSTEM

(71) Applicant: Samsung Electronics Co., Ltd., Suwon-si (KR)

(72) Inventors: Kyungjun CHOI, Suwon-si (KR); Sungjin PARK, Suwon-si (KR); Jaeyeon SHIM, Suwon-si (KR); Youngrok JANG, Suwon-si (KR); Hyoungju JI, Suwon-si (KR)

(21) Appl. No.: 19/085,958

(22) Filed: Mar. 20, 2025

(30) Foreign Application Priority Data
Mar. 22, 2024 (KR) 10-2024-0039937
Oct. 4, 2024 (KR) 10-2024-0134536

(51) Int. Cl. H04B 7/0456; H04L 5/00

(52) U.S. Cl. CPC H04B 7/0456; H04L 5/0044

(57) ABSTRACT

The disclosure relates to a 5G or 6G communication system for supporting a higher data transmission rate. Methods and apparatus are provided for dynamic precoder determination in a wireless communication system. The method of a terminal comprises: receiving, from a base station, configuration information on a precoder resource block group (PRG) granularity; receiving, from the base station, downlink control information (DCI) including information indicating a size of a physical resource block (PRB) bundling; and identifying the PRG granularity based on the information and at least one downlink (DL) subband.

### CROSS-REFERENCE TO RELATED APPLICATIONS

This application is based on and claims priority under 35 U.S.C. § 119 to Korean Patent Application Nos. 10-2024-0039937 and 10-2024-0134536 filed on Mar. 22, 2024, and Oct. 4, 2024, in the Korean Intellectual Property Office, the disclosure of which is herein incorporated by reference in its entirety.

### BACKGROUND

### 1. Field

The disclosure relates to operations of a user equipment (UE) and a gNB in a wireless communication system. More particularly, the disclosure relates to an apparatus and a method for enabling a UE to perform subband non-overlapping full duplex (SBFD) operations.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services and, in particular, a method for efficiently performing a subband non-overlapping full duplex (SBFD) operation by a terminal.

### SUMMARY

Embodiments set forth herein are to provide a device and a method capable of effectively providing services in a mobile communication system.

A mobile communication (or wireless communication) system according to an embodiment of the disclosure includes a method for receiving a physical downlink shared channel (PDSCH) in connection with subband non-overlapping full duplex (SBFD).

Embodiments set forth herein provide a device and a method capable of effectively providing services in a mobile communication system. Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of a control resource set configuration of a downlink control channel in a wireless communication system according to an embodiment of the disclosure;

FIG. 5 illustrates a structure of a downlink control channel in a wireless communication system according to an embodiment of the disclosure;

FIG. 6 illustrates a method in which a base station and a UE transmit/receive data in consideration of a downlink data channel and a rate matching resource in a wireless communication system according to an embodiment of the disclosure;

FIG. 7 illustrates an example of frequency domain resource allocation with regard to a PDSCH in a wireless communication system according to an embodiment of the disclosure;

FIG. 8 illustrates an example of time domain resource allocation with regard to a PDSCH in a wireless communication system according to an embodiment of the disclosure;

FIG. 9 illustrates an example of time domain resource allocation according to a subcarrier spacing with regard to a data channel and a control channel in a wireless communication system according to an embodiment of the disclosure;

FIG. 10 illustrates radio protocol structures of a base station and a UE in single cell, carrier aggregation, and dual connectivity situations in a wireless communication system according to an embodiment of the disclosure;

FIG. 11 illustrates a random access procedure in a wireless communication system according to an embodiment of the disclosure;

FIG. 12 illustrates TDD configurations and SBFD configurations in a wireless communication system according to an embodiment of the disclosure;

FIG. 13 illustrates a scheduled PDSCH and a precoder assumption in a TDD system according to an embodiment of the disclosure;

FIG. 14 illustrates a scheduled PDSCH and a precoder assumption in an SBFD system according to an embodiment of the disclosure;

FIG. 15 illustrates a flowchart of a method for receiving a PDSCH based on SBFD in a wireless communication system according to an embodiment of the disclosure;

FIG. 16 illustrates scheduled PDSCH repeated reception and a precoder assumption in an SBFD system according to an embodiment of the disclosure;

FIG. 17A illustrates two TCI states in a wireless communication system according to an embodiment of the disclosure;

FIG. 17B illustrates a PDSCH scheduling method in a wireless communication system according to an embodiment of the disclosure;

FIG. 18 illustrates a structure of a UE in a wireless communication system according to an embodiment of the disclosure; and

FIG. 19 illustrates a structure of a base station in a wireless communication system according to an embodiment of the disclosure.

### DETAILED DESCRIPTION

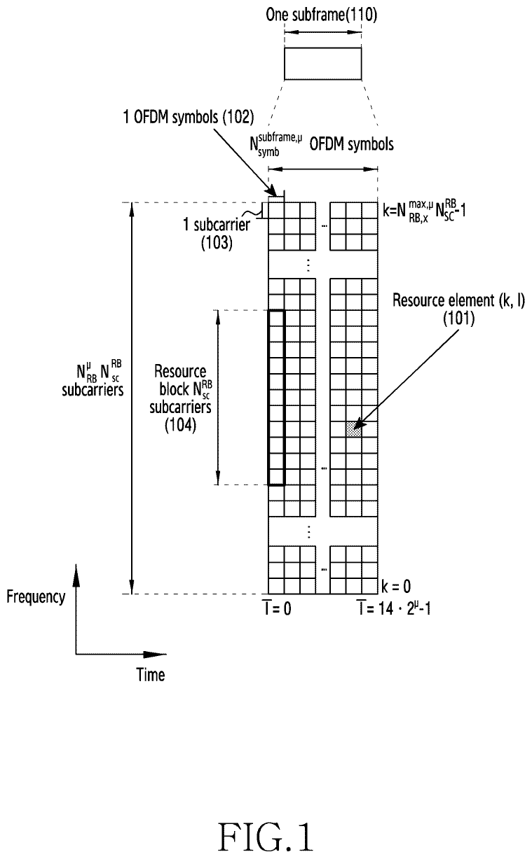

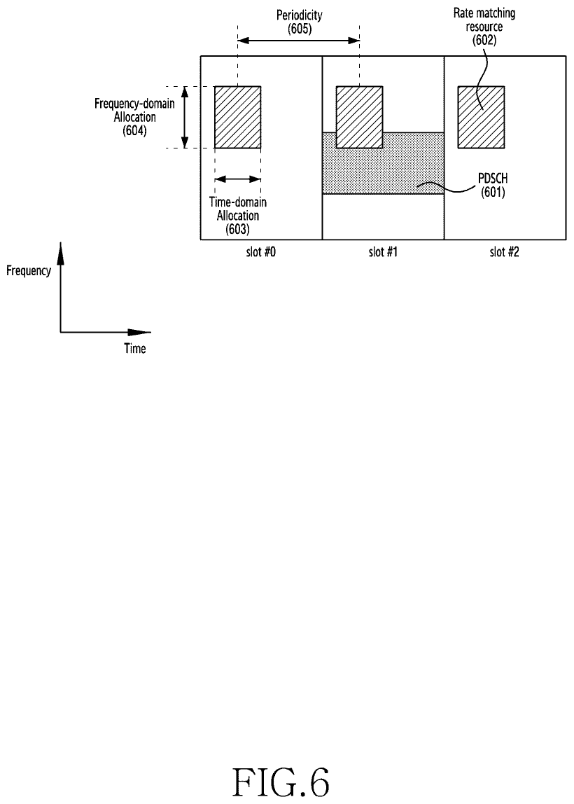

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to FDD and TDD systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery lifetime such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

FIG. 1 illustrates a basic structure of a time-frequency domain in a wireless communication system according to an embodiment of the disclosure.

Referring to FIG. 1, the horizontal axis represents a time domain, and the vertical axis represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} C. (for example, 12) consecutive REs may constitute one resource block (RB) 104.

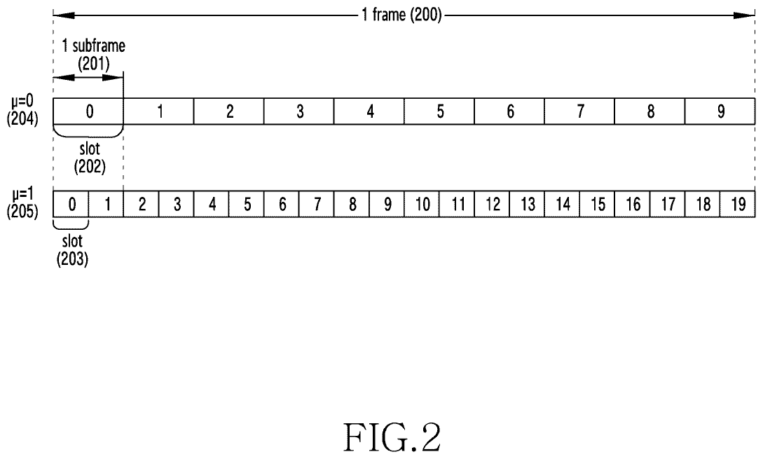

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values μ for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{subframe,μ} may differ depending on the subcarrier spacing configuration value μ, and the number of slots per one frame Nₛₗₒₜ^{frame,μ} slot may differ accordingly. Nₛₗₒₜ^{subframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

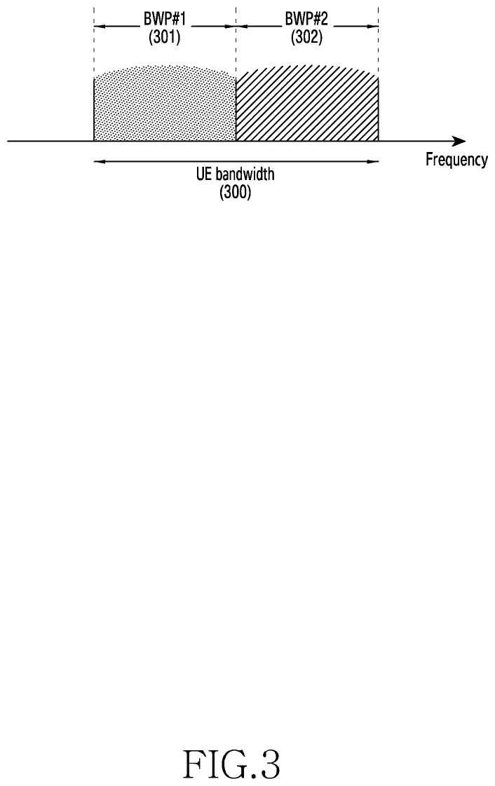

FIG. 3 illustrates an example of bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, n3, n4, n5}, |
| (subcarrier spacing) | |
| cyclicPrefix | ENUMERATED { extended } |

(cyclic prefix)
}

Of course, the bandwidth part configuration is not limited to the above example, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

According to various embodiments of the disclosure, the bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

According to an embodiment, in connection with the bandwidth part configuring method, UEs, before RRC-connected, may receive configuration information regarding the initial bandwidth part (initial BWP) through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change may indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof may be as follows:
PSS: A signal which becomes a reference signal for downlink time/frequency synchronization, and may provide partial information of a cell ID;
SSS: A reference for downlink time/frequency synchronization, and may provide the remaining cell ID information not provided by the PSS. Additionally, the SSS may serve as a reference signal for PBCH demodulation of a PBCH;
PBCH: may provide an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like; and
SS/PBCH block: may include a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example. Obviously, the examples given below are not limiting.

TABLE 4

| | |
|---|---|
| - | Identifier for DCI formats - [1] bit |
| - | Frequency domain resource assignment -[┌log₂ (N_{RB}^{UL, BWP} (N_{RB}^{UL, BWP} + 1)/2)┐] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH - [2] bits |
| - | Uplink/ supplementary uplink (UL/SUL) indicator - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example. Obviously, the examples given below are not limiting.

TABLE 5

| - | Carrier indicator-0 or 3 bits | | |
|---|---|---|---|
| - | UL/SUL indicator-0 or 1 bit | | |
| - | Identifier for DCI formats-[1] bits | | |
| - | Bandwidth part indicator-0, 1 or 2 bits | | |
| - | Frequency domain resource assignment | | |
| | | • | $For resource allocation type 0 , ⌈ {N}_{R B}^{UL , B W P} / P ⌉ bits$ |
| | | • | $For resource allocation type 1 , ⌈ {log}_{2} ( {N}_{R B}^{UL , B W P} ( {N}_{R B}^{UL , B W P} + 1 ) / 2 ) ⌉ bits$ |
| - | Time domain resource assignment-1, 2, 3, or 4 bits | | |
| - | Virtual resource block (VRB)-to-physical resource block (PRB) mapping-0 or 1 | | |
| | bit, only for resource allocation type 1. | | |
| | | • | 0 bit if only resource allocation type 0 is configured; |
| | | • | 1 bit otherwise. |
| - | Frequency hopping flag-0 or 1 bit, only for resource allocation type 1. | | |
| | | • | 0 bit if only resource allocation type 0 is configured; |
| | | • | 1 bit otherwise. |
| - | Modulation and coding scheme-5 bits | | |
| - | New data indicator-1 bit | | |
| - | Redundancy version-2 bits | | |
| - | HARQ process number-4 bits | | |
| - | 1st downlink assignment index-1 or 2 bits | | |
| | | • | 1 bit for semi-static HARQ-ACK codebook; |
| | | • | 2 bits for dynamic HARQ-ACK codebook with single HARQ-ACK |
| | | codebook. | |
| - | 2nd downlink assignment index-0 or 2 bits | | |
| | | • | 2 bits for dynamic HARQ-ACK codebook with two HARQ-ACK sub- |
| | | codebooks; | |
| | | • | 0 bit otherwise. |
| - | TPC command for scheduled PUSCH-2 bits | | |
| - | $SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉$ | | |
| | | • | $⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH transmission ;$ |
| | | transmission; | |
| | | • | ┌log₂(N_{SRS})┐ bits for codebook based PUSCH transmission. |

| | |
|---|---|
| - | Precoding information and number of layers-up to 6 bits |
| - | Antenna ports-up to 5 bits |
| - | SRS request-2 bits |
| - | Channel state information (CSI) request-0, 1, 2, 3, 4, 5, or 6 bits |
| - | Code block group (CBG) transmission information-0, 2, 4, 6, or 8 bits |
| - | Phase tracking reference signal (PTRS)-demodulation reference signal (DDMRS) |

association-0 or 2 bits.

| | |
|---|---|
| - | beta_offset indicator-0 or 2 bits |
| - | DMRS sequence initialization-0 or 1 bit |

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example. Obviously, the examples given below are not limiting.

TABLE 6

| | |
|---|---|
| - | Identifier for DCI formats - [1] bit |
| - | Frequency domain resource assignment -[┌log₂ (N_{RB}^{DL, BWP} (N_{RB}^{DL, BWP} + 1)/2)┐] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Physical uplink control channel (PUCCH) resource indicator - 3 bits |
| - | PDSCH-to-HARQ feedback timing indicator - [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example. Obviously, the examples given below are not limiting.

TABLE 7

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{DL, BWP}/P┐bits |
| | • | For resource allocation type 1, ┌log₂(N_{RB}^{DL, BWP}(N_{RB}^{DL, BWP} + 1)/2)┐bits |
| - | Time domain resource assignment -1, 2, 3, or 4 bits | |
| - | VRB-to-PRB mapping - 0 or 1 bit, only for resource allocation type 1. | |
| | • | 0 bit if only resource allocation type 0 is configured; |
| | • | 1 bit otherwise. |

| | |
|---|---|
| - | Physical resource block (PRB) bundling size indicator - 0 or 1 bit |
| - | Rate matching indicator - 0, 1, or 2 bits |
| - | Zero power (ZP) channel state information (CSI)-reference signal (RS) trigger - 0, 1, |

or 2 bits
For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, and Search Space]

Hereinafter, a downlink control channel in a 5G communication system will be described in more detail with reference to the accompanying drawings.

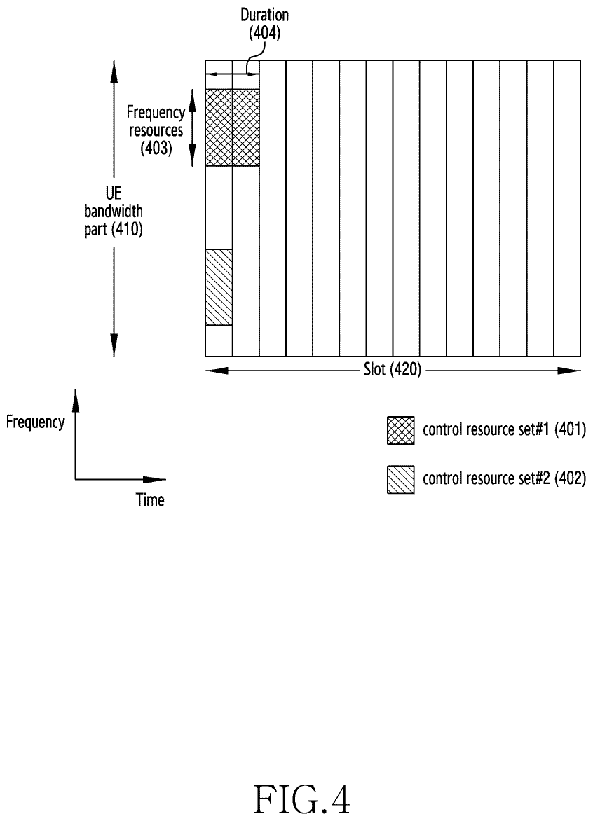

FIG. 4 illustrates an example of a control resource set (CORESET) configuration with regard to a downlink control channel in a wireless communication system according to an embodiment of the disclosure. FIG. 4 illustrates an example in which a UE bandwidth part 410 is configured along the frequency axis, and two control resource sets (control resource set #1 420 and control resource set #2 401) are configured within one slot 402 along the time axis. The control resource sets 401 and 402 may be configured in a specific frequency resource 410 within the entire UE bandwidth part 403 along the frequency axis. One or multiple OFDM symbols may be configured along the time axis, and this may be defined as a control resource set duration 404. Referring to the example illustrated in FIG. 4, CORESET #1 401 is configured to have a control resource set duration corresponding to two symbols, and CORESET #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE may mean that information such as a control resource set identity, the control resource set's frequency location, and the control resource set's symbol duration is provided. For example, the control resource set may include the following pieces of information: given in Table 8 below. Obviously, the examples given below are not limiting.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG-bundle, |

allContiguousRBs},

| | |
|---|---|
| interleaverSize | ENUMERATED {n2, n3, n6} |

```
      (interleaver size)
      shiftIndex
  INTEGER(0..maxNrofPhysicalResourceBlocks−1)
  OPTIONAL
      (interleaver shift)
  },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |

}

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (QCLed) with a DMRS transmitted in a corresponding control resource set. Obviously, the example given below is not limiting.

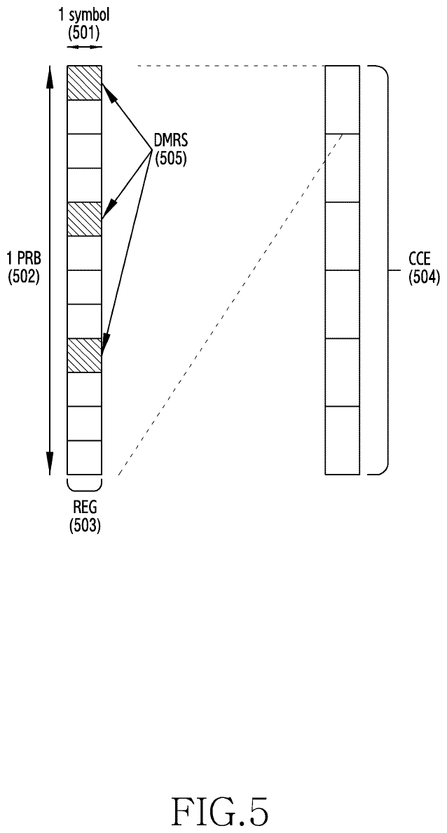

FIG. 5 illustrates a structure of a downlink control channel in a wireless communication system according to an embodiment of the disclosure;

Referring to FIG. 5, FIG. 5 illustrates an example of a basic unit of time and frequency resources constituting a downlink control channel available in a 5G system. According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the control resource set may include the following pieces of information: given in Table 9 below. Obviously, the examples given below are not limiting.

TABLE 9

| | |
|---|---|
| SearchSpace ::= | SEQUENCE { |

-- Identity of the search space. SearchSpaceId = 0 identifies the SearchSpace configured via PBCH
(MIB) or ServingCellConfigCommon.

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
  }
        OPTIONAL,
```

| | |
|---|---|
| duration (monitoring duration) | INTEGER (2..2559) |
| monitoringSymbolsWithinSlot | BIT STRING (SIZE (14)) |
| | OPTIONAL, |

(monitoring symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

},

| | |
|---|---|
| searchSpaceType | CHOICE { |

```
  (search space type)
    -- Configures this search space as common search space (CSS) and DCI formats to monitor.
```

| | |
|---|---|
| common | SEQUENCE { |

```
  (common search space)
  }
```

| | |
|---|---|
| ue-Specific | SEQUENCE { |

```
  (UE-specific search space)
      -- Indicates whether the UE monitors in this USS for DCI formats 0-0 and 1-0 or for formats
0-1 and 1-1.
```

| | |
|---|---|
| formats | ENUMERATED {formats0-0-And-1-0, |

```
formats0-1-And-1-1},
  ...
    }
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

Combinations of DCI formats and RNTIs given below may be monitored in a UE-specific search space. Obviously, the examples given below are not limiting;
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

Enumerated RNTIs may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and/or
Transmit power control for SRS RNTI (TPC-SRS-RNTI): used to indicate a power control command regarding an SRS.

The DCI formats enumerated above may follow the definitions given in Table 10 below. Obviously, the examples given below are not limiting.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the |
| | PRB(s) and OFDM symbol(s) where |
| | UE may assume no transmission |
| | is intended for the UE |
| 2_2 | Transmission of TPC commands for PUCCH and PUSCH |
| 2_3 | Transmission of a group of TPC commands for SRS |
| | transmissions by one or more UEs |

In a 5G system, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i where \qquad [ Equation 1 ]$$

L: aggregation level;
n_{Cl}: carrier index;
N_{CCE,p}: total number of CCEs existing in control resource set p;
n_{s,f}^{μ}: slot index;
M_{s,max}^{(L)}: number of PDCCH candidates at aggregation level L;
m_{s,n}_{_{Cl}}=0, . . . , M_{s,max}^{(L)}−1: PDCCH candidate index at aggregation level L;
i=0, . . . , L−1;
Y_{p,n}_{_{s,f}}_{^{μ}}=(Aₚ·Y_{p,n}_{_{s,f}}_{^{μ}}₋₁) mod D, Y_{p,-1}=n_{RNTI}≠0, Aₚ=39827 for pmod3=0, Aₚ=39829 for pmod3=1, Aₚ=39839 for pmod3=2, D=65537; and
n_{RNTI}: UE identity.

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 10), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PDSCH: Regarding Frequency Resource Allocation]

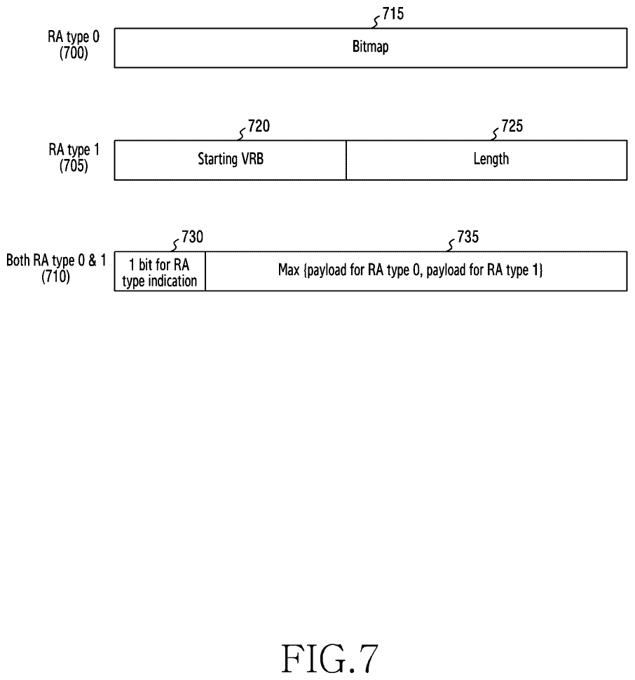

FIG. 7 illustrates an example of frequency domain resource allocation with regard to a physical downlink shared channel (PDSCH) in a wireless communication system according to an embodiment of the disclosure.

Referring to FIG. 7, FIG. 7 illustrates three types of frequency-axis resource assignment methods, including type-0 700, type-1 705, and dynamic switch 710, which can be configured through an upper layer in an NR wireless communication system.

Referring to FIG. 7, in the case in which a UE is configured to use only resource type 0 through upper layer signaling (700), partial downlink control information (DCI) for allocating a PDSCH to the UE include a bitmap including N_{RBG} bits. Conditions for this may be described again later. As used herein, N_{RBG} refers to the number of resource block groups (RBGs) determined according to the BWP size allocated by a BWP indicator and upper layer parameter rbg-Size, as in Table 11 below, and data is transmitted in RBGs indicated as “1” by the bitmap.

TABLE 11

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In case that the UE is configured to use only resource type 1 through higher layer signaling (705), some DCI for allocating PDSCHs to the UE includes frequency domain resource allocation information including log₂(N_{RB}^{DL,BWP}+1)/2 bits. The conditions for this will be described again later. The base station may thereby configure a starting VRB 7-20 and the length 7-25 of a frequency domain resource allocated continuously therefrom.

In the case in which the UE is configured to use both resource type 0 and resource type 1 through upper layer signaling (7-10), partial DCI for allocating a PDSCH to the corresponding UE includes frequency domain resource allocation information including as many bits as the larger value 7-35 between the payload 7-15 for configuring resource type 0 and the payload 7-20 and 7-25 for configuring resource type 1. The conditions for this will be described again later. One bit may be added to the foremost part (MSB) of the frequency domain resource allocation information inside the DCII, and if the bit has the value of “0,” use of resource type 0 may be indicated, and if the bit has the value of “1,” use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 12 or Table 13 below may be transmitted from the base station to the UE. Obviously, the example given above is not limiting.

TABLE 12
PDSCH-TimeDomainResourceAllocationList information element

```
  PDSCH-TimeDomainResourceAllocationList ::= SEQUENCE (SIZE (1..maxNrofDL-Allocations)) OF
  PDSCH-TimeDomainResourceAllocation
  PDSCH-TimeDomainResourceAllocation ::= SEQUENCE {
```

| | |
|---|---|
| k0 | INTEGER(0..32) |

OPTIONAL, -- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

```
  (start symbol and length of PDSCH)
  }
```

TABLE 13
PUSCH-TimeDomainResourceAllocationList information element

PUSCH-TimeDomainResourceAllocationList ::= SEQUENCE (SIZE(1..maxNrofUL-Allocations)) OF
PUSCH-TimeDomainResourceAllocation
PUSCH-TimeDomainResourceAllocation ::= SEQUENCE {

| | |
|---|---|
| k2 | INTEGER(0..32) OPTIONAL, -- Need S |

(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The base station may notify the UE of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

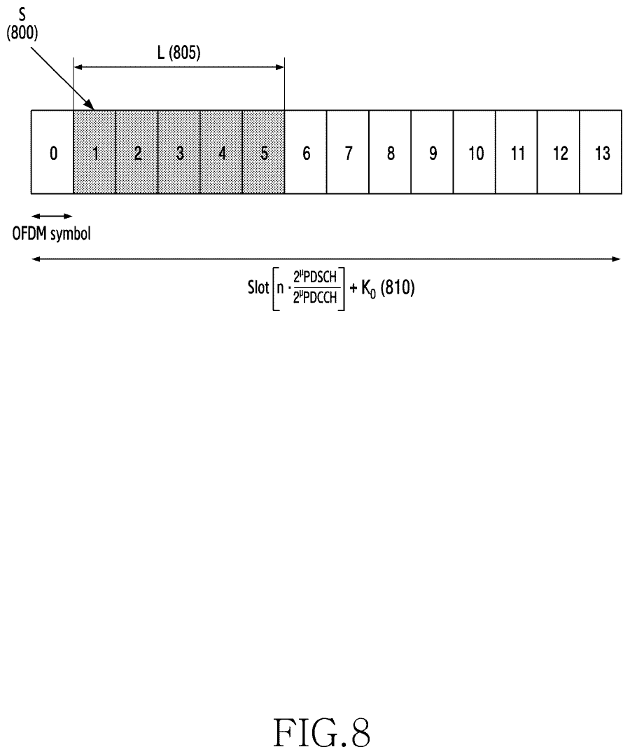

FIG. 8 illustrates an example of time domain resource allocation with regard to a PDSCH in a wireless communication system according to an embodiment of the disclosure.

Referring to FIG. 8, the base station may indicate the time domain location of a PDSCH resource according to the subcarrier spacing (SCS) (μ_{PDSCH}, μ_{PDCCH}) of a data channel and a control channel configured by using an upper layer, the scheduling offset (K0) value, and the OFDM symbol start location 800 and length 805 within one slot dynamically indicated through DCI.

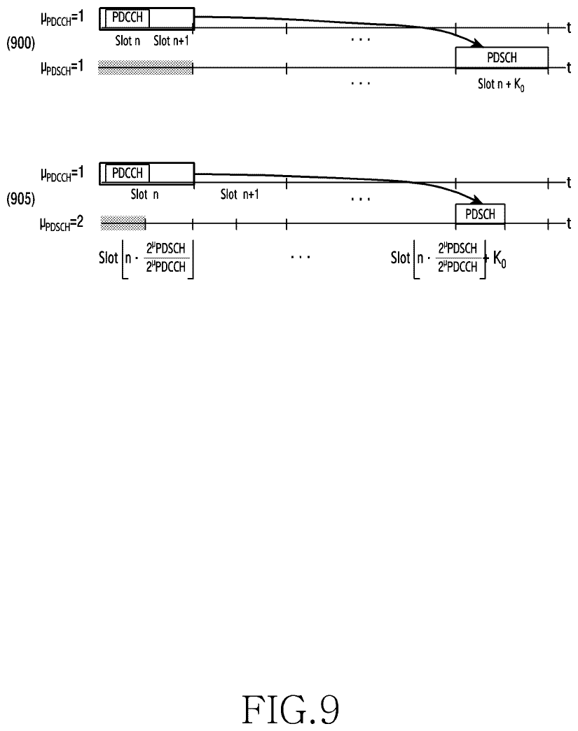

FIG. 9 illustrates an example of time domain resource allocation according to a subcarrier spacing with regard to a data channel and a control channel in a wireless communication system according to an embodiment of the disclosure.

Referring to FIG. 9, if the data channel and the control channel have the same subcarrier spacing (900, μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (905, PDSCH≠μPDCCH), the slot number for data and that for control are different, and the base station and the UE may accordingly generate a scheduling offset in conformity with a predetermined slot offset K0 with reference to the subcarrier spacing of the PDCCH.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 16 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 16 through upper signaling. If PUSCH transmission is operated by a configured grant, parameters applied to the PUSCH transmission are applied through configuredGrantConfig (upper signaling) in Table 14 except for dataScramblingIdentityPUSCH, txConfig, codebookSubset, maxRank, and scaling of UCI-OnPUSCH, which are provided by pusch-Config (upper signaling) in Table 15. If provided with transformPrecoder inside configuredGrantConfig (upper signaling) in Table 14, the UE applies tp-pi2BPSK inside pusch-Config in Table 15 to PUSCH transmission operated by a configured grant.

TABLE 14
ConfiguredGrantConfig ::= SEQUENCE {

| | |
|---|---|
| frequencyHopping ENUMERATED {intraSlot, interSlot} | OPTIONAL, -- Need S, |

cg-DMRS-Configuration DMRS-UplinkConfig,

| | |
|---|---|
| mcs-Table ENUMERATED {qam256, qam64LowSE} | OPTIONAL, -- Need S |

mcs-TableTransformPrecoder ENUMERATED {qam256, qam64LowSE} OPTIONAL, -- Need
S

| | |
|---|---|
| uci-OnPUSCH SetupRelease { CG-UCI-OnPUSCH } | OPTIONAL, -- Need M |

resourceAllocation ENUMERATED { resourceAllocationType0, resourceAllocationType1,
dynamicSwitch },

| | |
|---|---|
| rbg-Size ENUMERATED {config2} | OPTIONAL, -- Need S |

powerControlLoopToUse ENUMERATED {n0, n1},
p0-PUSCH-Alpha P0-PUSCH-AlphaSetId,

| | |
|---|---|
| transformPrecoder ENUMERATED {enabled, disabled} | OPTIONAL, -- Need S |

nrofHARQ-Processes INTEGER(1..16),
repK ENUMERATED {n1, n2, n4, n8},

| | |
|---|---|
| repK-RV ENUMERATED {s1-0231, s2-0303, s3-0000} | OPTIONAL, -- Need R |

```
periodicity ENUMERATED {
  sym2, sym7, sym1x14, sym2x14, sym4x14, sym5x14, sym8x14, sym10x14, sym16x14,
sym20x14,
  sym32x14, sym40x14, sym64x14, sym80x14, sym128x14, sym160x14, sym256x14,
sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym16x12, sym20x12,
sym32x12,
  sym40x12, sym64x12, sym80x12, sym128x12, sym160x12, sym256x12, sym320x12,
sym512x12, sym640x12,
  sym1280x12, sym2560x12
},
```

| | |
|---|---|
| configuredGrantTimer INTEGER (1..64) | OPTIONAL, -- Need R |

```
rrc-ConfiguredUplinkGrant SEQUENCE {
  timeDomainOffset INTEGER (0..5119),
  timeDomainAllocation INTEGER (0..15),
  frequencyDomainAllocation BIT STRING (SIZE(18)),
  antennaPort INTEGER (0..31),
```

| | |
|---|---|
| dmrs-SeqInitialization INTEGER (0..1) | OPTIONAL, -- Need R |

precodingAndNumberOfLayers INTEGER (0..63),

| | |
|---|---|
| srs-ResourceIndicator INTEGER (0..15) | OPTIONAL, -- Need R |

```
  mcsAndTBS INTEGER (0..31),
  frequencyHoppingOffset INTEGER (1..maxNrofPhysicalResourceBlocks−1) OPTIONAL, --
Need R
  pathlossReferenceIndex INTEGER (0..maxNrofPUSCH-PathlossReferenceRSs−1),
  ...
} OPTIONAL, -- Need R
...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 15, which is upper signaling, is “codebook” or “nonCodebook.”

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated uplink BWP inside a serving cell, and the PUSCH transmission may be based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 15, the UE may not expect scheduling through DCI format 0_1.

TABLE 15
PUSCH-Config ::= SEQUENCE {

| | |
|---|---|
| dataScramblingIdentityPUSCH INTEGER (0..1023) | OPTIONAL, -- Need S |
| txConfig ENUMERATED {codebook, nonCodebook} | OPTIONAL, -- Need S |

dmrs-UplinkForPUSCH-MappingTypeA SetupRelease { DMRS-UplinkConfig } OPTIONAL,
-- Need M
dmrs-UplinkForPUSCH-MappingTypeB SetupRelease { DMRS-UplinkConfig } OPTIONAL,
-- Need M

| | |
|---|---|
| pusch-PowerControl PUSCH-PowerControl | OPTIONAL, -- Need M |
| frequencyHopping ENUMERATED {intraSlot, interSlot} | OPTIONAL, -- Need S |

frequencyHoppingOffsetLists SEQUENCE (SIZE (1..4)) OF INTEGER (1..
maxNrofPhysicalResourceBlocks−1)
OPTIONAL, -- Need M
resourceAllocation ENUMERATED { resourceAllocationType0, resourceAllocationType1,
dynamicSwitch},
pusch-TimeDomainAllocationList SetupRelease { PUSCH-TimeDomainResourceAllocationList }
OPTIONAL, -- Need M

| | |
|---|---|
| pusch-AggregationFactor ENUMERATED { n2, n4, n8 } | OPTIONAL, -- Need S |
| mcs-Table ENUMERATED {qam256, qam64LowSE} | OPTIONAL, -- Need S |

mcs-TableTransformPrecoder ENUMERATED {qam256, qam64LowSE} OPTIONAL, --
Need S

| | |
|---|---|
| transformPrecoder ENUMERATED {enabled, disabled} | OPTIONAL, -- Need S |

codebookSubset ENUMERATED {fullyAndPartialAndNonCoherent,
partialAndNonCoherent,nonCoherent}
OPTIONAL, -- Cond codebookBased
maxRank INTEGER (1..4) OPTIONAL, -- Cond codebookBased

| | |
|---|---|
| rbg-Size ENUMERATED { config2} | OPTIONAL, -- Need S |
| uci-OnPUSCH SetupRelease { UCI-OnPUSCH} | OPTIONAL, -- Need M |
| tp-pi2BPSK ENUMERATED {enabled} | OPTIONAL, -- Need S |

...
}

Next, codebook-based PUSCH transmission will be described. The codebook-based PUSCH transmission may be dynamically scheduled through DCI format 0_0 or 0_1, and may be semi-statically operated by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI may refer to the SRS resource corresponding to the SRI, among SRS resources transmitted prior to the PDCCH including the corresponding SRI. The TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent,” “partialAndNonCoherent,” or “noncoherent,” based on UE capability reported by the UE to the base station. If the UE reported “partialAndNonCoherent” as UE capability, the UE may not expect that the value of codebookSubset (upper signaling) may be configured as “fullyAndPartialAndNonCoherent.” In addition, if the UE reported “nonCoherent” as UE capability, UE may not expect that the value of codebookSubset (upper signaling) may be configured as “fullyAndPartialAndNonCoherent” or “partialAndNonCoherent.” If nrofSRS-Ports inside SRS-ResourceSet (upper signaling) indicates two SRS antenna ports, the UE does not expect that the value of codebookSubset (upper signaling) may be configured as “partialAndNonCoherent.”

The UE may have one SRS resource set configured therefor, wherein the value of usage inside SRS-ResourceSet (upper signaling) is “codebook,” and one SRS resource may be indicated through an SRI inside the corresponding SRS resource set. If multiple SRS resources are configured inside the SRS resource set wherein the value of usage inside SRS-ResourceSet (upper signaling) is “codebook,” the UE expects that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and instruct the UE to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be semi-statically operated by a configured grant. If at least one SRS resource is configured inside an SRS resource set wherein the value of usage inside SRS-ResourceSet (upper signaling) is “nonCodebook,” non-codebook-based PUSCH transmission may be scheduled for the UE through DCI format 0_1.

With regard to the SRS resource set wherein the value of usage inside SRS-ResourceSet (upper signaling) is “nonCodebook,” one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission may be updated.

If the configured value of resourceType inside SRS-ResourceSet (upper signaling) is “aperiodic,” the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00.” The corresponding DCI may not indicate cross carrier or cross BWP scheduling. In addition, if the value of SRS request indicates the existence of a NZP CSI-RS, the NZP CSI-RS may be located in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) may be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook,” and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook,” and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [Regarding CA/DC]

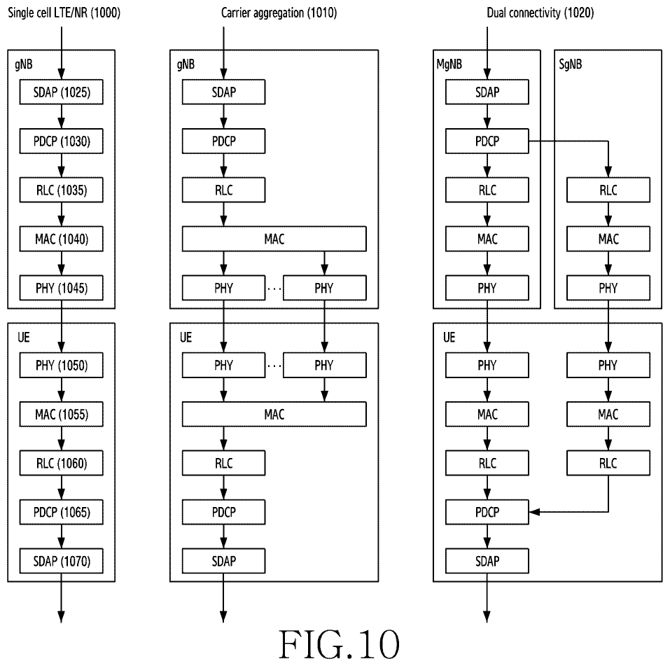

FIG. 10 illustrates radio protocol structures of a base station and a UE in single cell, carrier aggregation, and dual connectivity situations according to an embodiment of the disclosure.

Referring to FIG. 10, the radio protocol of a next-generation mobile communication system includes an NR service data adaptation protocol (SDAP) 1025 or 1070, an NR packet data convergence protocol (PDCP) 1030 or 1065, an NR radio link control (RLC) 1035 or 1060, and an NR medium access control (MAC) 1040 or 1055, on each of UE and NR base station sides. Obviously, the above example is not limiting, and the radio protocol may include a larger or smaller number of layers.

The main functions of the NR SDAP 1025 or 1070 may include some of functions below:
Transfer of user plane data;
Mapping between a QoS flow and a DRB for both DL and UL;
Marking QoS flow ID in both DL and UL packets; and/or
Reflective QoS flow to DRB mapping for the UL SDAP PDUs.

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QOS) reflection configuration 1-bit indicator (NAS reflective QoS) of the SDAP header and the access stratum (AS) QOS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1030 or 1065 may include some of functions below. The main functions of the NR PDCP 1030 or 1065 may include some of the following functions: below. Obviously, the examples given below are not limiting:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 1035 or 1060 may include some of the following functions: below. Obviously, the examples given below are not limiting:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

Among the above-described functions, the in-sequence delivery of the NR RLC device may refer to a function of delivering RLC SDUs, received from the lower layer, to the upper layer in sequence. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all RLC SDUs received until now to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery function of the NR RLC device may refer to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 1040 or 1055 may be connected to multiple NR RLC layer devices configured in one UE, and the main functions of the NR MAC may include some of functions below. Obviously, the examples given below are not limiting:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

An NR PHY layer 1045 or 1050 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the example given above is not limiting.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 1000. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 1010. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 1020.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may provide a PDCCH repetitive transmission method through multiple transmission/reception points (TRPs). According to the disclosure, the PDCCH reception reliability of a UE may be improved. Specific methods thereof will be described hereinafter through the embodiments below.

Hereinafter, embodiments of the disclosure will be described in detail in conjunction with the accompanying drawings. An embodiment of the disclosure may be applied to systems such as frequency division dup[lex (FDD), time division duplex (TDD), and cross division duplex (XDD), but may not be limited thereto. As used herein, upper signaling (or upper layer signaling”) may refer to a method for transferring signals from a base station to a UE by using a downlink data channel of a physical layer, or from the UE to the base station by using an uplink data channel of the physical layer, or the signals thereof. For example, the upper signaling (or upper layer signaling) may also be referred to as “RRC signaling,” “PDCP signaling,” or “medium access control (MAC) control element (MAC CE),” but may not be limited thereto.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. In the following description, for the sake of descriptive convenience, non-coherent joint transmission (NC-JT) case may refer to a case in which the UE receives a PDSCH to which cooperative communication is applied, based on conditions similar to those described above. That is, the NC-JT case in the disclosure may include reception of a PDSCH to which cooperative communication is applied, and whether the cooperative communication is applied may be identified according to at least one of the above-described conditions/methods or at least one combination thereof.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments, but they are not independent of each other, and one or more embodiments may be applied simultaneously or in combination.

In the following description of the disclosure, upper layer signaling may refer to signaling corresponding to at least one signaling among the following signaling, or a combination of one or more thereof. Obviously, the examples given below are not limiting:
Master information block (MIB);
System information block (SIB) or SIB X (X=1, 2, . . . );
Radio resource control (RRC);
Medium access control (MAC) control element (CE);

In addition, L1 signaling may refer to signaling corresponding to at least one signaling method among signaling methods using the following physical layer channels or signaling, or a combination of one or more thereof. Obviously, the examples given below are not limiting:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

[SBFD operations]

Meanwhile, subband non-overlapping full duplex (SBFD) has been introduced as a new duplex scheme based on NR in 3GPP. According to the technology referred to as SBFD, a part of the downlink resource is used as an uplink resource in a TDD spectrum of frequencies of 6 GHz or less or frequencies of 6 GHz or higher such that as much uplink transmission as the increased uplink resource is received form a UE, thereby expanding the UE's uplink coverage, and feedback regarding downlink transmission is received from the UE in the expanded uplink resource, thereby reducing the feedback delay. In the disclosure, a UE which received information regarding whether the SBFD is supported or not from the gNB, and which may perform uplink transmission in a part of the downlink resource, may be referred to as an SBFD-capable UE for convenience of description. The following schemes may be considered in order to define the SBFD scheme in specifications, and in order for the SBFD-capable UE to determine that the SBFD is supported in a specific cell (or frequency/frequency band). Obviously, the following example is not limitative.

According to the first scheme, another frame structure type (for example, frame structure type 2) may be introduced to define the SBFD in addition to the frame structure type of a legacy unpaired spectrum (or time division duplex (TDD)) or paired spectrum (or frequency division duplex (FDD)). Frame structure type 2 may be defined such that the same is supported at a specific frequency or frequency band, or the gNB may indicate, to the UE, whether the SBFD is supported or not, by using system information. The SBFD-capable UE may receive system information indicating whether the SBFD is supported or not and may determine whether the SBFD is supported or not in a specific cell (or frequency/frequency band).

According to the second scheme, it may be indicated whether the SBFD is additionally supported at a specific frequency or frequency band of a legacy unpaired spectrum (or TDD) without definition regarding a new frame structure type. In the second scheme, it may be defined whether the SBFD is additionally supported at a specific frequency or frequency band of a legacy unpaired spectrum, or the gNB may indicate, to the UE, whether the SBFD is supported or not, by using system information. The SBFD-capable UE may receive system information indicating whether the SBFD is supported or not and may determine whether the SBFD is supported or not in a specific cell (or frequency/frequency band).

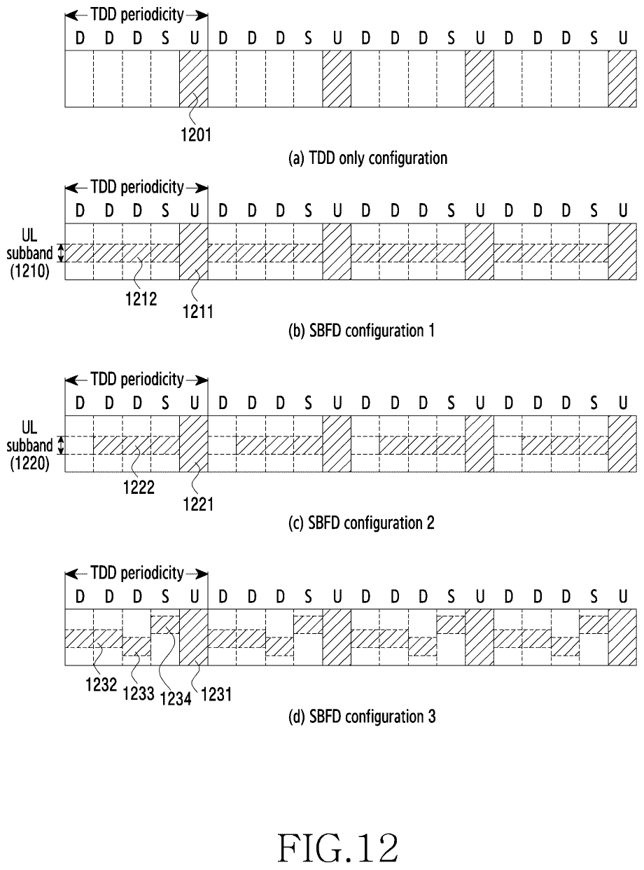

Information regarding whether the SBFD is supported or not in the first and second schemes described above may be information (for example, SBFD resource configuration information described later with reference to FIG. 12) indirectly indicating whether the SBFD is supported or not by additionally configuring a part of the downlink resource as the uplink resource, in addition to configurations regarding TDD uplink-downlink (UL-DL) resource configuration information indicating the TDD's downlink slot (or symbol) resource and uplink slot (or symbol) resource, or may be information directly indicating whether the SBFD is supported or not.

In the disclosure, the SBFD-capable UE may receive a synchronization signal block during the initial cell access for accessing a cell (or gNB), thereby acquiring cell synchronization. The SBFD-capable UE and a legacy TDD UE may undergo the same cell synchronization acquisition process. Thereafter, the SBFD-capable UE may determine whether the cell supports the SBFD or not through an MIB acquisition or SIB acquisition or random access process.

System information for transmitting information regarding whether the SBFD is supported or not may be distinguished from and transmitted separately from system information for a UE (for example, legacy TDD UE) supporting a different version of specifications in the cell. The SBFD-capable UE may determine whether the SBFD is supported or not by acquiring all or part of the system information transmitted separately from the system information for the legacy TDD UE. In case that the SBFD-capable UE acquires only the system information for the legacy TDD UE or acquires system information indicating that the SBFD is not supported, the SBFD-capable UE may determine that the cell (or gNB) supports TDD only.

In case that information regarding whether the SBFD is supported or not is included in system information for a UE (for example, legacy TDD UE) supporting a different version of specifications, the information regarding whether the SBFD is supported or not may be inserted last so as not to affect the legacy TDD UE's system information acquisition. In case that the SBFD-capable UE fails to acquire the information regarding whether the SBFD is supported or not, which has been inserted last, or acquires information indicating that the SBFD is not supported, the SBFD-capable UE may determine that the cell (or gNB) supports TDD only.

In case that information regarding whether the SBFD is supported or not is included in system information for a UE (for example, legacy TDD UE) supporting a different version of specifications, the information regarding whether the SBFD is supported or not may be transmitted by using a separate PDSCH so as not to affect the legacy TDD UE's system information acquisition. For example, a UE that does not support the SBFD may receive a first SIB (or SIB1) including legacy TDD-related system information by using a first PDSCH. A UE that supports the SBFD may receive a first SIB (or SIB1) including legacy TDD-related system information by using a first PDSCH, and may receive a second SIB including SBFD-related system information by using a second PDSCH. The first PDSCH and the second PDSCH may be scheduled by a first PDCCH and a second PDCCH, and the cyclic redundancy code (CRC) of the first PDCCH and the second PDCCH may be scrambled by the same RNTI (for example, SI-RNTI). The UE that supports the SBFD may acquire a search space for monitoring the second PDCCH from the first PDSCH's system information and, if fails to acquire the same (that is, if the first PDSCH's system information is not included in information regarding the search space), may receive the second PDCCH in the same search space as the first PDCCH's search space.

In case that the SBFD-capable UE determines that the cell (or gNB) supports TDD only, as described above, the SBFD-capable UE may perform the same random access procedure and data/control signal transmission/reception as the legacy TDD UE.

The gNB may configure a separate random access resource for each of legacy TDD UEs or SBFD-capable UEs (for example, an SBFD-capable UE that supports duplex communication and an SBFD-capable UE that supports half-duplex communication), and may transmit configuration information regarding the random access resource (configuration information or control information indicating time-frequency resources that may be used for a PRACH) to an SBFD-capable UE through system information. System information for transmitting information regarding the random access resource may be distinguished from and transmitted separately from system information for a UE (for example, legacy TDD UE) supporting a different version of specifications in the cell.

The gNB may configure a random access resource for a TDD UE and may additionally configure a separate random access resource for an SBFD-capable UE. The SBFD-capable UE may use the random access resource for the TDD UE, or the SBFD-capable UE may not use the random access resource for the TDD UE. In the latter case, the SBFD-capable UE may always use only the separate random access resource for the SBFD-capable UE.

The gNB may indicate, to the SBFD-capable UE, whether the random access resource for the TDD UE can be used or not. Whether the random access resource for the TDD UE can be used or not may be included in an SIB and indicated accordingly. For example, the SIB may have a separate random access resource configured for the SBFD-capable UE and, together with the separate random access resource configuration, may indicate whether the random access resource for the TDD UE can be used or not. Whether the random access resource for the TDD UE can be used or not may be indicated by one bit. If the one bit is “0” (or FALSE), the SBFD-capable UE cannot use the random access resource for the TDD UE. If the one bit is “1” (or TRUE), the SBFD-capable UE can use the random access resource for the TDD UE.

The gNB may assess the type of a UE that attempts to access a cell, based on the random access resource used by the UE. As used herein, the UE or gNB's “assessment” may be used interchangeably with “determination” or “identification.” For example, an SBFD-capable UE may transmit a PRACH through a separate random access resource for the SBFD-capable UE, the gNB may determine that that the SBFD-capable UE attempts a cell access, when receiving the PRACH. For example, a TDD UE may transmit a PRACH through a random access resource for the TDD UE, and the gNB may determine that that the TDD UE attempts a cell access, when receiving the PRACH. For reference, in case that the SBFD-capable UE is allowed to transmit a RPACH through the TDD UE's random access resource, the gNB may find it ambiguous whether the type of the UE that has transmitted the PRACH is a TDD UE or an SBFD-capable UE. In this case, the gNB may assume that the UE's type is always a TDD UE.

In case that the gNB determines that the UE's type is an SBFD-capable UE, the gNB may schedule msg2, msg3, msg4, or the like for the UE, based on an uplink subband configuration. For example, when the gNB schedules reception of msg2 and msg4, msg2 and msg4 may be scheduled so as not be received in the uplink subband (when the UE receives a PDSCH including msg2 and msg4, the PDSCH is received in a frequency resource other than the uplink subband). When the gNB schedules a msg3 PUSCH, the msg3 PUSCH may be scheduled so as to be transmitted in the uplink subband.

In case that the gNB determines that the UE's type is a TDD UE, the gNB cannot use the uplink subband configuration when scheduling msg2, msg3, and msg4 for the UE. For example, even if a downlink symbol or flexible symbol has an uplink subband configured therefor, the gNB may assume that the UE cannot acquire uplink subband configuration information. When the gNB schedules a msg3 PUSCH for the UE, the msg3 PUSCH may be scheduled for a flexible symbol or uplink symbol. In other words, the msg3 PUSCH cannot be scheduled for the uplink subband.

Alternatively, the gNB may not configure a separate random access resource for the SBFD-capable UE and may configure a common random access resource for all UEs in the cell. In this case, configuration information regarding the random access resource may be transmitted to all UEs in the cell through system information, and the SBFD-capable UE may perform a random access to the random access resource after receiving the system information. Thereafter, the SBFD-capable UE may complete the random access process and may proceed to an RRC connected mode for transmitting/receiving data with the cell. After the RRC connected mode, the SBFD-capable UE may receive, from the gNB, an upper layer signal or a physical signal which may be used to determine that some frequency resources of downlink time resources are configured as uplink resources, thereby performing an SBFD operation (for example, transmitting uplink signals in uplink resources).

In case that the SBFD-capable UE determines that the cell supports SBFD, capability information including at least one piece of information from among information regarding whether the UE supports SBFD or not, information regarding whether full-duplex communication or half-duplex communication is supported or not, the number of provided (or supported) transmission or reception antennas, and the like may be transmitted to the gNB, thereby informing the gNB that the UE that attempts an access is the SBFD-capable UE. Alternatively, in case that half-duplex communication support requires to be implemented by the SBFD-capable UE, the capability information may not include information regarding whether half-duplex communication is supported or not. The SBFD-capable UE may report the capability information to the gNB through a random access process, may report the capability information to the gNB after completing the random access process, or may report the capability information to the gNB after proceeding to an RRC connected mode for transmitting/receiving data with the cell.

The SBFD-capable UE may support half-duplex communication such that either uplink transmission or downlink reception is performed at one moment, as in the case of the legacy TDD UE, or may support full-duplex communication such that both uplink transmission and downlink reception are performed at one moment. Therefore, whether the half-duplex communication or full-duplex communication is supported may be reported to the gNB by the SBFD-capable UE through a capability report. After the reporting, the gNB may configure, for the SBFD-capable UE, whether the SBFD-capable UE is supposed to perform transmission/reception by using the half-duplex communication or full-duplex communication. In case that the SBFD-capable UE reports capability regarding the half-duplex communication to the gNB, a switching gap may be necessary to change the RF between transmission and reception in case of operating based on FDD or TDD because no duplexer generally exists.

In general, a UE may establish a radio link with a network through a random access procedure, based on system information and synchronization with the network acquired in a cell search process. A contention-based random access scheme or a contention-free random access scheme may be used. In case that the UE performs cell selection and cell reselection in the initial cell access phase, the contention-based random access scheme may be used for the purpose of transitioning from an RRC_IDLE state to an RRC_CONNECTED state, for example. The contention-free random access may be used to reconfigure uplink synchronization in case that downlink data has arrived, in the case of a handover, or in the case of position measurement.

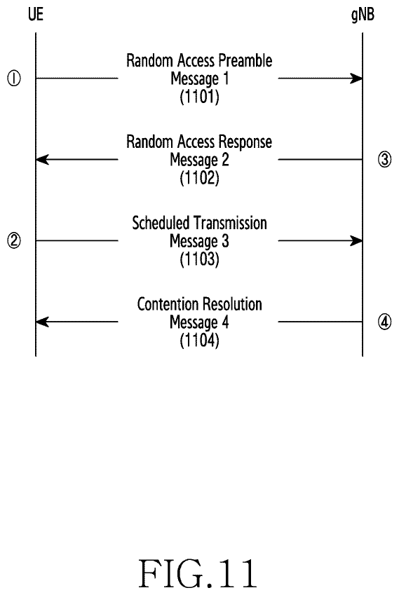

FIG. 11 illustrates a random access procedure in a wireless communication system according to an embodiment of the disclosure.

Referring to FIG. 11, a contention-based random access procedure is illustrated, as an example. In addition, although not illustrated, the gNB may transmit a synchronization signal block as described in previous embodiments. The gNB may periodically transmit a synchronization signal block by using beam sweeping. For example, the gNB may transmit a synchronization signal block including PSS/SSS (synchronization signal) and PBCH (broadcast channel) signals by using a maximum of 64 different beams for 5 ms, and multiple synchronization signal blocks may be transmitted by using different beams. The UE may detect (select) a synchronization signal block having an optimal beam direction (for example, a beam direction, the received signal strength of which is highest or higher than a predetermined threshold), and may transmit a preamble to the gNB by using a physical random access channel (PRACH) resource related to the detected synchronization signal block. For example, in the first step 1101 of the random access procedure, the UE may transmit a random access preamble (or message 1 msg1)) to the gNB. Upon receiving the random access preamble, the gNB may measure the transmission delay value between the UE and the gNB, and may make uplink synchronization. Specifically, the UE may transmit a random access preamble selected arbitrarily from a random access preamble set given by system information in advance. The random access preamble's initial transmission power may be determined according to the pathloss between the gNB and the UE, measured by the UE. In addition, the UE may determine the random access preamble's transmission beam direction (or transmission beam or beam), based on the synchronization signal block received from the gNB, and may transmit a random access preamble by applying the determined transmission beam direction.

In the second step 1102, the gNB may transmit a random access response (RAR) (or message 2 (msg2)) to the UE in response to the detected random access attempt. The gNB may transmit an uplink transmission timing control command to the UE from the transmission delay value measured from the random access preamble received in the first step. In addition, the gNB may transmit a power control command and an uplink resource to be used by the UE as scheduling information. The scheduling information may include control information regarding the UE's uplink transmission beam. The RAR is transmitted through a PDSCH and may include at least one of the following pieces of information. Obviously, the following examples are not limitative:
A random access preamble sequence index detected by the network (or gNB);
A temporary cell radio network temporary identifier (TC-RNTI);
An uplink scheduling grant; and/or
A timing advance value.

If the UE fails to receive scheduling information (RAR) regarding message 3 from the gNB for a predetermined period of time in the second step 1102, the first step 1101 may be repeated. In case of repeating the first step, the UE may increase the random access preamble's transmission power by a predetermined step (this is referred to as power ramping) and then transmit the same, thereby increasing the probability that the gNB may receive the random access preamble.

In the third step 1103, the UE may transmit uplink information (scheduled transmission or message 3 (msg3)) including its UE identity (UE contention resolution identity or, if the UE already has a valid UE identity (C-RNTI) in the cell before the random access procedure is initiated, the valid UE identity) to the gNB through a physical uplink shared channel (PUSCH) by using the uplink resource allocated in the second step 1102. The PUSCH may be referred to as a msg3 PUSCH. The transmission timing of the PUSCH for transmitting message 3 may follow the uplink transmission timing control command received from the gNB in the second step 1102. In addition, the transmission timing of the PUSCH for transmitting message 3 may be determined in consideration of the power control command received from the gNB in the second step 1102 and the random access preamble's power ramping value. The PUSCH for transmitting message 3 may be the first uplink data signal transmitted from the UE to the gNB after the UE has transmitted the random access preamble.

Lastly, in the fourth step 1104, in case of determining that the UE has performed a random access without contention with other UEs, the gNB may transmit a message (contention resolution message (CR message) or message 4 (msg4)) including the identity of the UE that has transmitted uplink data in the third step 1103 to the UE. In this regard, in case that multiple UEs receive the same TC-RNTI in the second step 1102, the multiple UEs that have received the same TC-RNTI may transmits message 3 including their UE contention resolution identity to the gNB in the third step 1103, and the gNB may transmit message 4 (CR message) including one of multiple UE identities for the sake of contention resolution. The UE may determine that the random access is successful upon receiving message 4 (CR message) including its UE identity from the gNB in the fourth step 1104 (or in case that message 3 including a C-RNTI is transmitted in the third step 1103, and UE-specific control information including a CRC based on the C-RNTI is received through a PDCCH in the fourth step 1104). Therefore, the UE may identify successful contention upon identifying that message 4 (CR message) includes its UE identity among multiple UEs that have receive the same TC-RNTI from the gNB. Furthermore, the UE may transmit a HARQ-ACK/NACK to the gNB through a physical uplink control channel (PUCCH) to indicate whether message 4 has been successfully received or not.

If the data transmitted by the UE in the third step 1103 contends with data from another UE, and the gNB thus fails to receive data signals from the UE, the gNB may no longer perform data transmission to the UE. Accordingly, if the UE fails to receive data transmitted from the gNB for predetermined period of time in the fourth step 1104, the UE may determine that the random access procedure has failed, and may restart from the first step 1101.

As described above, in the first step 1101 of the random access process, the UE may transmit a random access preamble through a PRACH. Each cell may have 64 available preamble sequences, and four types of long preamble formats and nine short preamble formats may be used according to the type of transmission. The UE may generate 64 preamble sequences by using a cyclic shift value and a root sequence index signaled by system information, may randomly select one sequence, and may use the same as a preamble.

The gNB may provide the UE with configuration information regarding random access resources, for example, control information (or configuration information) indicating time-frequency resources that may be used for a PRACH, by using at least one of an SIB, upper layer signaling (radio resource control (RRC) information, or downlink control information (DCI). In connection with frequency resources for PRACH transmission, the PB point at which transmit starts may be indicated to the UE, and the number of used RBs may be determined according to the applied subcarrier spacing and In connection with time resources for PRACH transmission, the UE may be informed of a preconfigured PRACH configuration periodicity, subframe indices including a PRACH occasions (which may be used interchangeably with transmission occasions), starting symbols, the number of PRACH occasions within a slot, and the like through PRACH configuration indices (0 to 255), as in Table 16 below. The UE may determine the validity of PRACH occasions indicated by PRACH configuration indices, and may determine that valid PRACH occasions are solely PRACH occasions that may be used to transmit a random access preamble. The UE may identify the time and frequency resources to transmit a random access preamble through the PRACH configuration indices, random access configuration information included in the SIB, and the index of the SSB selected by the UE, and may transmit the selected sequence to the gNB as a preamble.

TABLE 16

| | | | | | | | number of | |
|---|---|---|---|---|---|---|---|---|
| | | | | | | | time-domain | |
| | | | | | | Number of | PRACH | |
| PRACH | | | | | | PRACH slots | occasions | |
| configuration | Preamble | | | Subframe | Starting | within a | within a | PRACH |
| Index | format | n_{SD} | | number | symbol | subframe | PRACH slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| . . . | . . . | | | | | | | |
| 104 | A1 | 1 | 0 | 1, 4, 7 | 0 | 2 | 6 | 2 |
| . . . | . . . | | | | | | | |
| 251 | C | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, 5, 6, | 0 | 2 | 2 | 6 |
| | | | | 7, 8, 9 | | | | |
| 255 | C2 | 1 | 0 | 1, 3, 5, 7, 9 | 0 | 2 | 2 | 6 |

Meanwhile, there may be a need for a scheme in which an SBFD-capable UE determines the validity of a PRACH occasion through an SBFD configuration and a PRACH configuration index for performing PRACH transmission, and then performs PRACH transmission through the PRACH occasion deemed to be valid, and a procedure for the SBFD-capable UE in case that the valid PRACH occasion overlaps downlink reception, according to an embodiment of the disclosure.

FIG. 12 (e.g., (a), (b), (c), and (d) as illustrated in FIG. 12) illustrate TDD configurations and SBFD configurations in a wireless communication system according to an embodiment of the disclosure (e.g., (a), (b), (c), and (d) as illustrated in FIG. 12).

FIG. 12 (e.g., (a) as illustrated in FIG. 12) illustrates a case in which TDD is operated in a specific frequency band. In the cell that operates TDD, the gNB may transmit/receive signals including data/control information in a downlink slot (or symbol), an uplink slot (or symbol) 1201, or a flexible slot (or symbol), based on configurations regarding TDD UL-DL resource configuration information indicating downlink slot (or symbol) resources and uplink slot (or symbol) resources of a legacy TDD UE or an SBFD-capable UE and TDD.

It may be assumed in FIG. 12 (e.g., (a), (b), (c) and (d) as illustrated in FIG. 12) that a DDDSU slot format is configured according to TDD UL-DL resource configuration information. In this case, “D” denotes a slot entirely configured by downlink symbols, “U” denotes a slot entirely configured by uplink symbols, and “S” denotes a slot which is neither “D” nor “U,” for example, a slot including downlink symbols and uplink symbols or including flexible symbols. It may be assumed for convenience of description that “S” is configured by twelve downlink symbols and two flexible symbols. The DDDSU slot format may be repeated according to the TDD UL-DL resource configuration information. For example, the TDD configuration may have a repetition periodicity configured by five slots (for example, 5 ms in the case of 15 kHz SCS, or 2.5 ms in the case of 30 kHz SCS).

Next, FIG. 12 (e.g., (b), (c), and (d) as illustrated in FIG. 12) illustrates cases in which TDD and SBFD are operated together in a specific frequency band.

Referring to FIG. 12 (e.g., (b) as illustrated in FIG. 12), some bands among the cell's frequencies may be configured for the UE as a frequency band 1210 in which uplink transmission is possible. The configured band may be referred to as an UL subband. The UL subband may be applied to all symbols of all slots. The UE may transmit uplink channels or signals scheduled for all symbols 1212 in the UL subband. However, the UE cannot transmit uplink channels or signals in bands other than the UL subband.

Referring to FIG. 12 (e.g., (c) as illustrated in FIG. 12), some bands among the cell's frequencies may be configured for the UE as a frequency band 1220 in which uplink transmission is possible, and a time interval in which the frequency band is activated may be configured for the UE. The frequency band 1220 may be referred to as a UL subband. In FIG. 12 (e.g., (c) as illustrated in FIG. 12), the UL subband may be deactivated in the first slot, and may be activated in the remaining slots. Therefore, the UE may transmit uplink channels or signals in the UL subband 1222 of the remaining slots. Accordingly, although the UL subband is activated with regard to each slot, whether or not to activate the same may be configured with regard to each symbol.

Referring to FIG. 12 (e.g., (d) as illustrated in FIG. 12), a time-frequency resource in which uplink transmission is possible may be configured for the UE. One or more time-frequency resources may be configured for the UE as time-frequency resources in which uplink transmission is possible. For example, some frequency bands 1232 of the first slot and the second slot may be configured as a time-frequency resource in which uplink transmission is possible. In addition, some frequency bands 1233 of the third slot and some frequency bands 1234 of the fourth slot may be configured as time-frequency resources in which uplink transmission is possible.

In the following description, a time-frequency resource in which uplink transmission is possible in downlink symbols or flexible symbols may be referred to as an SBFD resource/UL subband.

### [PRG Granularity]

The UE may assume that a precoder granularity or a precoder resource block group (PRG) is a series of PRBs along the frequency domain. The same may be identical to one value among {n2, n4, wideband}, wherein n2 and n4 correspond to 2 and 4, respectively, and may be referred to as narrowbands.

In case that a wideband is determined, the UE does not expect that the same may be scheduled nonconsecutively as PRBs in the frequency domain, and the UE may assume that the same precoding is applied to resources associated with the same TCI state or the same QCL assumption.

In case that one value among {2, 4} (narrowband values) is determined, the PRG may split the PRBs included in the BWP into consecutive PRBs. The number of actually consecutive PRBs included in each PRG may be one or larger.

The first PRG size is given by P′_{BWP,i}−N_{BWP,i}^{start} mod P′_{BWP,i}, and the last PRG size is given by (N_{BWP,i}^{start}+N_{BWP,i}^{size})mod P′_{BWP,i} if (N_{BWP,i}^{start}+N_{BWP,i}^{size})mod P′_{BWP,i}≠0, and by P′_{BWP,i} if (N_{BWP,i}^{start}+N_{BWP,i}^{size}) mod P′_{BWP,i}=0.

In the case of a PDSCH including SIB1 scheduled by a PDCCH having a CRC scrambled by an SI-RNTI, and in case that the PDCCH is associated with CORESET 0 and Type0-PDCCH common search space and addressed by the SI-RNTI, the PRG may be split from the PRB having the lowest number of CORESET 0. Otherwise, the PRG may be split from common resource block (CRB) 0. The lowest subcarrier of CRB0 May be referred to as PointA, and the frequency position of PointA may be included in SIB1 or in an upper layer signal and transmitted to the UE.

In case that the UE receives a PDSCH scheduled by a PDCCH having a DCI format having a CRC scrambled by a C-RNTI, MCS-C-RNTI, or CS-RNTI, and in case that prb-BundlingType included in PDSCH-Config (upper layer signal) is not configured, the PRG granularity may be identical to 2 PRB.

Unless specified otherwise in the following description, the DCI format that schedules a PDSCH may be one of 1_1, 1_2, and 1_3. In addition, the DCI format's CRC may be scrambled by a C-RNTI, MCS-C-RNTI, or CS-RNTI.

### [Embodiment: Dynamic PRG Granularity]

The UE may be configured (prb-BundlingType=dynamicBundling) by the gNB so as to dynamically determine PRG granularity. In order to determine dynamic PRG granularity, the UE may receive an upper layer signal from the gNB.

As first information, BundleSizeSet1 may be configured. BundleSizeSet1 may include at least one value among {n2, n4, wideband, n2-wideband, n4-wideband}. For reference, in case that n2-wideband or n4-wideband is included, the UE may determine that two values are included, such as {n2, wideband} or {n4, wideband}. In the following description, the description that BundleSizeSet1 includes n2-wideband or n4-wideband may mean that BundleSizeSet1 includes two values.

As second information, BundleSizeSet2 may be configured. BundleSizeSet2 may include at least one value among {n2, n4, wideband}.

In case that the UE is configured by the gNB so as to determine dynamic PRG granularity, the DCI format that schedules a PDSCH (for example, DCI format 1_1, 1_2, or 1_3) may include a one-bit PRB bundling size indicator field. The UE may determine dynamic PRG granularity through the field.

If the one-bit PRB bundling size indicator field is “0,” the UE may determine that one value included in BundleSizeSet2 corresponds to dynamic PRG granularity.

If the one-bit PRB bundling size indicator field is “1,” the UE may determine that one value or two values (n2-wideband, n4-wideband) included in BundleSizeSet1 is a dynamic PRG granularity value. If BundleSizeSet1 includes one value (n2, n4, or wideband), the UE may determine that the one value is a dynamic PRG granularity value. If BundleSizeSet1 includes two values (n2-wideband or n4-wideband), the UE may select one of the two values and determine that the selected value is a dynamic PRG granularity value. The UE may select one of the two values as follows:

If a scheduled PDSCH is continuous in the frequency domain, and if the number of scheduled RBs is larger than half the number of RBs included in the active DL BWP, the UE may determine that the dynamic PRG granularity value is “wideband.” In case that the above condition is not satisfied (for example, if the scheduled PDSCH is discontinuous in the frequency domain, or if the number of scheduled RBs is smaller than or equal to half the number of RBs included in the active DL BWP), the UE may determine that the dynamic PRG granularity value is “n2” (BundleSizeSet1 includes n2-wideband as two values), or determine that the dynamic PRG granularity value is “n4” (BundleSizeSet1 includes n4-wideband as two values).

In the disclosure, the above-described PRG granularity determination method may be referred to as a BWP size-based determination method.

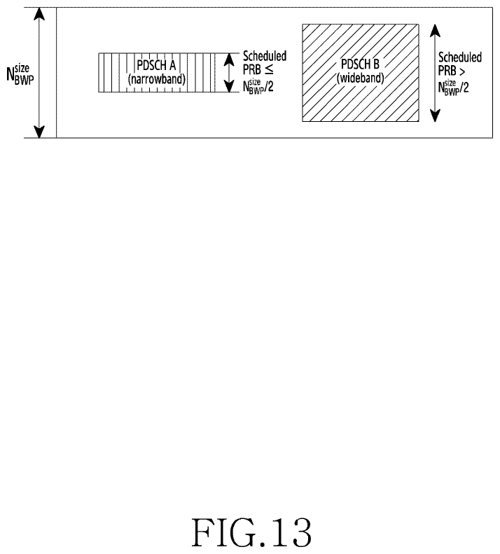

FIG. 13 illustrates a scheduled PDSCH and a precoder assumption in a TDD system according to an embodiment of the disclosure. Specifically, a BWP size-based determination method may be described.

Referring to FIG. 13, the BWP configured for the UE may include as many RBs as N_{BWP}^{size}. PDSCH A scheduled for the UE includes consecutive PRBs in the frequency domain, but the number of schedules PRBS is smaller than or equal to N_{BWP}^{size}/2. Therefore, the UE may determine that n2 (in case that n2-wideband has been configured) or n4 (in case that n4-wideband has been configured), which corresponds to a narrowband value, is PRG granularity.

PDSCH B scheduled for the UE includes consecutive PRBs in the frequency domain, and the number of schedules PRBS is larger than N_{BWP}^{size}/2. Therefore, the UE may determine that PRG granularity is “wideband.”

It may be assumed in the following description that a PDSCH has been scheduled across two DL subbands in an SBFD symbol. Among RBs schedules for the PDSCH, RBs scheduled in the first subband may be referred to as a first PDSCH segment. Among RBs schedules for the PDSCH, RBs scheduled in the second subband may be referred to as a second PDSCH segment.

In the following description, each PDSCH segment may be continuous in the frequency domain. For example, the first PDSCH segment may be a series of RBs in the frequency domain, and the second PDSCH segment may be a series of RBs in the frequency domain.

In case that PDSCH segments are discontinuous in the frequency domain, the UE may determine that the PDSCH segments have a narrowband value as the PRG granularity value. The above-described condition may be a superior condition to conditions described later. For example, it may be assumed in the following description that, if PDSCH segments have “wideband” as the PRG granularity value, each PDSCH segment is always continuous in the frequency domain.

In the following description, the UE may have n2-wideband or n4-wideband configured for BundleSizeSet1, and the one-bit PRB bundling size indicator field may indicate “1.” For convenience of description, if it is determined that “wideband” is the PRG granularity value, the same may be expressed as “wideband,” and if n2 (BundleSizeSet1 includes n2-wideband as two values) or n4 (BundleSizeSet1 includes n4-wideband as two values) is determined, the same may be expressed as “narrowband.”

In the first embodiment of the disclosure, in case that the UE has a PDSCH scheduled across two DL subbands in an SBFD symbol, the UE may expect that two PDSCH segments may always have the same PRG granularity. In other words, the UE may determine the PRG granularity value to be applied commonly to the two PDSCH segments. The PRG granularity value to be applied commonly to the two PDSCH segments may be determined in the following method. Obviously, the following example is not limitative.

In the following description, in case that symbols for which a PDSCH is scheduled span a non-SBFD symbol and an SBFD symbol, the UE may determine one of the two symbols. For example, the UE may determine the same, based on the type of the symbol that overlaps the DMRS of the PDSCH. In the first method, in case that at least one of the two PDSCH segments satisfies a specific condition, the UE may assume that the PRG granularity value of the two PDSCH segments is “wideband.” If all of the two PDSCH segments satisfy no specific condition, the UE may assume that the PRG granularity value of the two PDSCH segments is “narrowband.”

In the second method, in each of the two PDSCH segment satisfies a specific condition, the UE may assume that the PRG granularity value of the two PDSCH segments is “wideband.” If at least one of the two PDSCH segment does not satisfy the specific condition, the UE may assume that the PRG granularity value of the two PDSCH segments is “narrowband.”

In the third method, in case that the two PDSCH segments satisfy a specific condition, the UE may assume that the PRG granularity value of the two PDSCH segments is “wideband.” If two PDSCH segment do not satisfy the specific condition, the UE may assume that the PRG granularity value of the two PDSCH segments is “narrowband.” Unlike the first and second methods, the UE may herein determine whether the two PDSCH segment satisfy one specific condition or not, instead of determining whether each of the two PDSCH segments satisfies a specific condition or not.

In the second embodiment of the disclosure, in case that the UE has a PDSCH scheduled across two DL subbands in an SBFD symbol, the UE may expect that two PDSCH segments may have the same PRG granularity or different PRG granularities. In other words, the UE may determine the PRG granularity value to be applied separately to each of the two PDSCH segments. The PRG granularity value to be applied to each of two PDSCH segments may be identical or different. The PRG granularity value to be applied to each of two PDSCH segments may be determined in the following method. Obviously, the following example is not limitative.

In the fourth method, in case that each of two PDSCH segments satisfies the following specific condition, the UE may assume that the PRG granularity value of each PDSCH segment is “wideband.” If each PDSCH segment does not satisfy the specific condition, the UE may assume that the PRG granularity value of each PDSCH segment is “narrowband.” For example, if the first PDSCH segment satisfies the specific condition, the UE may assume that the PRG granularity value of the first PDSCH segment is “wideband.” Otherwise, the UE may assume that the PRG granularity value of the first PDSCH segment is “narrowband.” For example, if the second PDSCH segment satisfies the specific condition, the UE may assume that the PRG granularity value of the second PDSCH segment is “wideband.” Otherwise, the UE may assume that the PRG granularity value of the second PDSCH segment is “narrowband.”

In the third embodiment of the disclosure, in case that the UE has a PDSCH scheduled across two DL subbands in an SBFD symbol, the UE may assume that the PRG granularity of the two PDSCH segments is always “narrowband.” For example, the UE may not determine whether a separate specific condition is satisfied or not, and may assume that the PRG granularity of the two PDSCH segments is always “narrowband” if the UE has a PDSCH scheduled across two DL subbands in an SBFD symbol.

In case that the UE has a PDSCH scheduled across one DL subband in an SBFD symbol, the UE may determine (or identify) that the PRG granularity is “wideband” or “narrowband,” based on the DL subband's information. For example, in case that the scheduled PDSCH is continuous in one DL subband in the frequency domain, and in case that the number of RBs included in the PDSCH is larger than half the number of RBs included in the DL subband, the UE may determine that the PRG granularity is “wideband.” In case that the above condition is not satisfied (for example, in case that the scheduled PDSCH is discontinuous in one DL subband in the frequency domain, or in case that the number of RBs included in the PDSCH is not larger than half the number of RBs included in the DL subband, the UE may determine that the PRG granularity is “narrowband.”

Whether or not to apply an embodiment may be determined according to the UE's capability report. For example, in case that the UE is scheduled across two DL subbands in an SBFD symbol, the UE may report that the wideband cannot be used as the PRG granularity of the two PDSCH segments (or may not report that the wideband can be used). In this case, the UE may always determine the PRG granularity according to the thir4d embodiment. In case that the UE reports that the PRG granularity of the two PDSCH segments is “wideband,” the UE may determine the PRG granularity according to the first or second embodiment.

The gNB may configure the UE, through a separate upper layer signal, whether or not to use the third embodiment. More specifically, in case that the UE has a PDSCH scheduled across two DL subbands in an SBFD symbol through a separate upper layer signal, the gNB may cause the UE to always assume that the PRG granularity of the two PDSCH segments is “narrowband.” In addition, in case that the UE has a PDSCH scheduled across two DL subbands in an SBFD symbol through a separate upper layer signal, the gNB may cause the UE to determine the PRG granularity of the two PDSCH segments according to the first or second embodiment.

The specific condition applied by the UE may be at least one of the following conditions. The first to eighth conditions may be applied to the first, second, and fourth methods, and the eighth to fourteenth conditions may be applied to the third method.

As the first condition, the UE may determine that the specific condition is satisfied if the number of RBs included in the first PDSCH segment is larger than half N_BWP. The UE may determine that the specific condition is satisfied if the number of RBs included in the second PDSCH segment is larger than half N_BWP. The UE may determine that the specific condition is not satisfied if the number of RBs included in the first PDSCH segment is smaller than or equal to half N_BWP. The UE may determine that the specific condition is not satisfied if the number of RBs included in the second PDSCH segment is smaller than or equal to half N_BWP.

As the second condition, the UE may determine that the specific condition is satisfied if the number of RBs included in the first PDSCH segment is larger than half N_BWP/2. The UE may determine that the specific condition is satisfied if the number of RBs included in the second PDSCH segment is larger than half N_BWP/2. The UE may determine that the specific condition is not satisfied if the number of RBs included in the first PDSCH segment is smaller than or equal to half N_BWP/2. The UE may determine that the specific condition is not satisfied if the number of RBs included in the second PDSCH segment is smaller than or equal to half N_BWP/2.

As the third condition, the UE may determine that the specific condition is satisfied if the number of RBs included in the first PDSCH segment is larger than half N_SB,1. The UE may determine that the specific condition is satisfied if the number of RBs included in the second PDSCH segment is larger than half N_SB,2. The UE may determine that the specific condition is not satisfied if the number of RBs included in the first PDSCH segment is smaller than or equal to half N_SB,1. The UE may determine that the specific condition is not satisfied if the number of RBs included in the second PDSCH segment is smaller than or equal to half N_SB,2.

As the fourth condition, the UE may determine that the specific condition is satisfied if the number of RBs included in the first PDSCH segment is larger than half (N_SB,1+N_SB,2). The UE may determine that the specific condition is satisfied if the number of RBs included in the second PDSCH segment is larger than half (N_SB, 1+N_SB,2). The UE may determine that the specific condition is not satisfied if the number of RBs included in the first PDSCH segment is smaller than or equal to half (N_SB,1+N_SB,2). The UE may determine that the specific condition is not satisfied if the number of RBs included in the second PDSCH segment is smaller than or equal to half (N_SB,1+N_SB,2).

As the fifth condition, the UE may determine that the specific condition is satisfied if the number of RBs included in the first PDSCH segment is larger than half min {N_SB, 1, N_SB,2}. The UE may determine that the specific condition is satisfied if the number of RBs included in the second PDSCH segment is larger than half min {N_SB,1, N_SB,2}. The UE may determine that the specific condition is not satisfied if the number of RBs included in the first PDSCH segment is smaller than or equal to half min {N_SB,1, N_SB,2}. The UE may determine that the specific condition is not satisfied if the number of RBs included in the second PDSCH segment is smaller than or equal to half min {N_SB,1, N_SB,2}.

As the sixth condition, the UE may determine that the specific condition is satisfied if the number of RBs included in the first PDSCH segment is larger than half max {N_SB,1, N_SB,2}. The UE may determine that the specific condition is satisfied if the number of RBs included in the second PDSCH segment is larger than half max {N_SB,1, N_SB,2}. The UE may determine that the specific condition is not satisfied if the number of RBs included in the first PDSCH segment is smaller than or equal to half max {N_SB,1, N_SB,2}. The UE may determine that the specific condition is not satisfied if the number of RBs included in the second PDSCH segment is smaller than or equal to half max {N_SB,1, N_SB,2}.

As the seventh condition, the UE may determine that the specific condition is satisfied if the number of RBs included in the first PDSCH segment is larger than half (N_SB,1+N_SB,2)/2. The UE may determine that the specific condition is satisfied if the number of RBs included in the second PDSCH segment is larger than half (N_SB,1+N_SB,2)/2. The UE may determine that the specific condition is not satisfied if the number of RBs included in the first PDSCH segment is smaller than or equal to half (N_SB,1+N_SB,2)/2. The UE may determine that the specific condition is not satisfied if the number of RBs included in the second PDSCH segment is smaller than or equal to half (N_SB,1+N_SB,2)/2.

As the eighth condition, the UE may determine that the specific condition is satisfied if the number of RBs included in the first PDSCH segment is larger than half Y1. The UE may determine that the specific condition is satisfied if the number of RBs included in the second PDSCH segment is larger than half Y2. The UE may determine that the specific condition is not satisfied if the number of RBs included in the first PDSCH segment is smaller than or equal to half Y1. The UE may determine that the specific condition is not satisfied if the number of RBs included in the second PDSCH segment is smaller than or equal to half Y2. As used herein, Y1 and Y2 may be values configured for the UE by the gNB, Y1=Y2 may hold, and the gNB may configure one value for the UE.

As the ninth condition, the UE may determine that the specific condition is satisfied if the combined number of RBs included in the first PDSCH segment and the second PDSCH segment is larger than half (N_SB,1+N_SB,2). The UE may determine that the specific condition is not satisfied if the combined number of RBs included in the first PDSCH segment and the second PDSCH segment is smaller than or equal to half (N_SB,1+N_SB,2).

As the tenth condition, the UE may determine that the specific condition is satisfied if the combined number of RBs included in the first PDSCH segment and the second PDSCH segment is larger than half N_BWP. The UE may determine that the specific condition is not satisfied if the combined number of RBs included in the first PDSCH segment and the second PDSCH segment is smaller than or equal to half N_BWP.

As the eleventh condition, the UE may determine that the specific condition is satisfied if the combined number of RBs included in the first PDSCH segment and the second PDSCH segment is larger than half Y. The UE may determine that the specific condition is not satisfied if the combined number of RBs included in the first PDSCH segment and the second PDSCH segment is smaller than or equal to half Y. As used herein, Y may be a value configured for the UE by the gNB.

As the twelfth condition, the number of RBs included between the index (N_SB,1start) of the starting RB of the first PDSCH segment and the index (N_SB,2end) of the last RB of the second PDSCH segment may be A. For example, the UE may determine that the specific condition is satisfied if (A=N_SB,2end-N_SB,1start+1. A) is larger than half (N_SB,1+N_SB,2). The UE may determine that the specific condition is not satisfied if A is smaller than or equal to half (N_SB,1+N_SB,2).

As the thirteenth condition, the number of RBs included between the index (N_SB,1start) of the starting RB of the first PDSCH segment and the index (N_SB,2end) of the last RB of the second PDSCH segment may be A. For example, the UE may determine that the specific condition is satisfied if (A=N_SB,2end−N_SB,1start+1. A) is larger than half N_BWP. The UE may determine that the specific condition is not satisfied if A is smaller than or equal to half N_BWP.

As the fourteenth condition, the number of RBs included between the index (N_SB,1start) of the starting RB of the first PDSCH segment and the index (N_SB,2end) of the last RB of the second PDSCH segment may be A. For example, the UE may determine that the specific condition is satisfied if (A=N_SB,2end−N_SB,1start+1. A) is larger than half Y. The UE may determine that the specific condition is not satisfied if A is smaller than or equal to half Y. As used herein, Y may be a value configured for the UE by the gNB.

In the above conditions, N_BWP may be the number of RBs included in the DL BWP.

In the above conditions, N_SB,1 may be the number of RBs included in the first subband.

In the above conditions, N_SB,2 may be the number of RBs included in the second subband.

In the above conditions, N_SB,1 may be the larger number between the number of RBs included in the first subband and X.

In the above conditions, N_SB,2 may be the larger number between the number of RBs included in the second subband and X.

As used herein, the value of X may be a specific positive integer value. For example, the value of X may be 24 or may be 48. Alternatively, the value of X may be configured by the gNB. Alternatively, the value of X for N_SB,1 and the value of X for N_SB,2 may be identical to or different from each other.

The UE may have a PDSCH scheduled in only one DL subband in an SBFD symbol. Assuming that the UE has a PDSCH scheduled in the first subband, for convenience of description, the UE may determine whether a specific condition is satisfied or not with regard to the first PDSCH segment of the first subband, based on the above-described method 1, 2, or 3, and may not determine whether the specific condition is satisfied or not with regard to the second PDSCH segment because the second PDSCH segment has not been scheduled. For example, although the second PDSCH segment has not been scheduled, it may be determined that the specific condition is satisfied always.

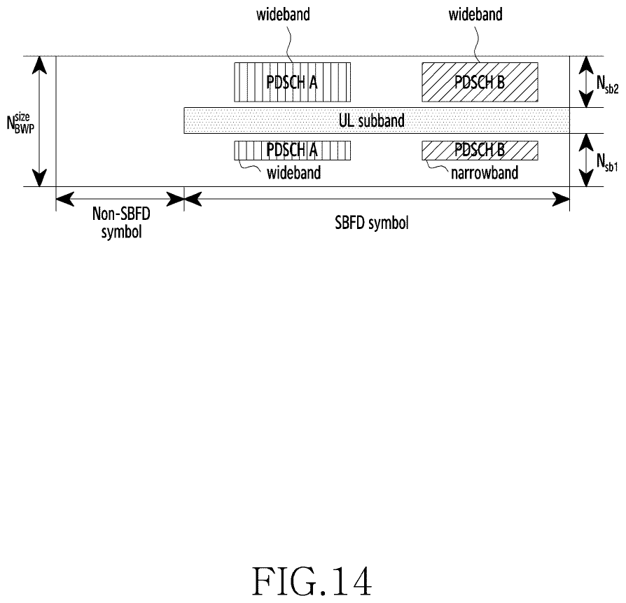

FIG. 14 illustrates a scheduled PDSCH and a precoder assumption in an SBFD system according to an embodiment of the disclosure. Specifically, a method for determining the PRG granularity of a PDSCH in an SBFD symbol may be described.

Referring to FIG. 14, the BWP configured for the UE may include as many RBs N_{BWP}^{size}. PDSCH A and PDSCH B scheduled for the UE may be scheduled across to DL subbands. Each DL subband may include consecutive PRBs.

PDSCH A may have a PRG granularity determined according to the first embodiment. In this case, the first PDSCH segment and the second PDSCH segment of PDSCH A may always have the same PRG granularity. The first PDSCH segment and the second PDSCH segment of PDSCH A may both have the PRG granularity of “wideband.”

PDSCH B may have a PRG granularity determined according to the third embodiment. In this case, the first PDSCH segment and the second PDSCH segment of PDSCH B may have respective PRG granularities. For example, the first PDSCH segment and the second PDSCH segment of PDSCH B may have different PRG granularities. The first PDSCH segment of PDSCH B may have the PRG granularity of “narrowband,” and the second PDSCH segment of PDSCH B may have the PRG granularity of “wideband.”

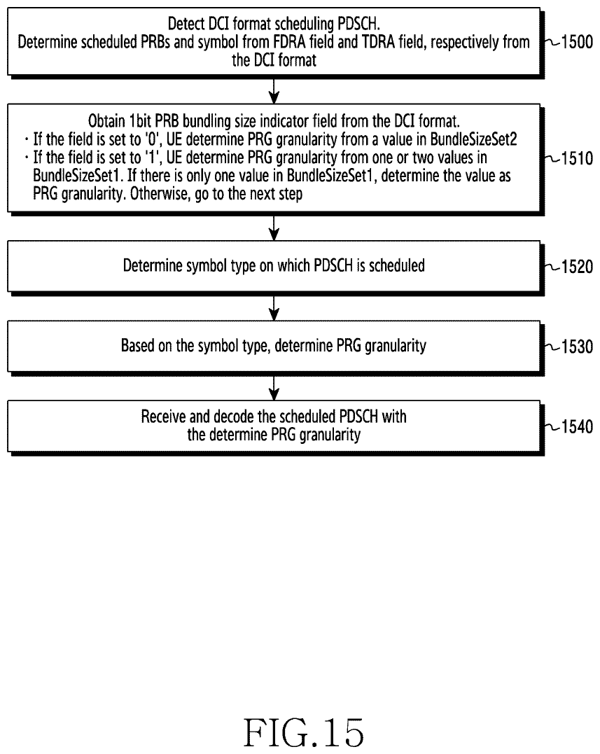

FIG. 15 illustrates a flowchart of a method for receiving a PDSCH, based on subband non-overlapping full duplex (SBFD), in a wireless communication system according to an embodiment of the disclosure.

Step 0 (1500): the UE may receive a DCI format that schedules a PDSCH. The DCI format may include a time domain resource assignment (TDRA) field that indicates symbols for which the PDSCH is scheduled, and a frequency domain resource assignment (FDRA) field that indicates scheduled RBs. The UE may determine symbols and RBs, for which the PDSCH is scheduled, through the TDRA field and the FDRA field.

First step 1510: the UE may acquire a one-bit PRB bundling size indicator field from the DCI format. If the field has a value of “0,” the UE may determine the PRG granularity value, based on one value configured in BundleSizeSet2. If the field has a value of “1,” the UE may determine the PRG granularity value, based on one or two values configured in BundleSizeSet1. If one value is configured in BundleSizeSet1, the UE may determine the PRG granularity value, based on one value. If two values are configured in BundleSizeSet1, the UE may determine the PRG granularity value, based on one of the two values. One of the two values may be determined in the third step.

Second step 1520: the UE may determine the type of the symbol for which the PDSCH is scheduled. The UE may determine whether the symbol for which the PDSCH is scheduled is a non-SBFD symbol or an SBFD symbol. If the symbol for which the PDSCH is scheduled spans a non-SBFD symbol and an SBFD symbol, the UE may determine one of the two symbols. The UE may make a determination, based on the type of the symbol that overlaps the DMRS of the PDSCH. For example, if the DMRS of the PDSCH overlaps a non-SBFD symbol, the UE may determine that the type is a non-SBFD symbol and, if the DMRS of the PDSCH overlaps an SBFD symbol, the UE may determine that the type is an SBFD symbol.

Third step 1530: if the type of the symbol for which the PDSCH is scheduled is a non-SBFD symbol, the UE may determine the PRG granularity according to the following BWP size-based determination method.
If RBs included in the PDSCH are consecutive in the frequency domain, and if the number of RBs included in the PDSCH is larger than N_BWP/2, the UE may determine that the PRG granularity value is “wideband.” Otherwise, the UE may determine that the PRG granularity value is “narrowband.”

If the type of the symbol for which the PDSCH is scheduled is an SBFD symbol, the UE may determine the PRG granularity according to at least one of the following conditions:
First condition: if RBs included in the first PDSCH segment are consecutive in the frequency domain, the number of RBs included in the first PDSCH segment is larger than Y1, and RBs included in the second PDSCH segment are consecutive in the frequency domain, and the number of RBs included in the second PDSCH segment is larger than Y2, the UE may determine that the PRG granularity value is “wideband.” Otherwise, the UE may determine that the PRG granularity value is “narrowband.”
Second condition: if RBs included in the first PDSCH segment are consecutive in the frequency domain, the number of RBs included in the first PDSCH segment is larger than Y1, or RBs included in the second PDSCH segment are consecutive in the frequency domain, and the number of RBs included in the second PDSCH segment is larger than Y2, the UE may determine that the PRG granularity value is “wideband.” Otherwise, the UE may determine that the PRG granularity value is “narrowband.”
Third condition: if RBs included in the first PDSCH segment are consecutive in the frequency domain, RBs included in the second PDSCH segment are consecutive in the frequency domain, and the number of all RBs from the starting RB of RBs included in the first PDSCH segment to the last RB of RBs included in the second PDSCH segment is larger than Y, the UE may determine that the PRG granularity value is “wideband.” Otherwise, the UE may determine that the PRG granularity value is “narrowband.”
In the first to third conditions, the first PDSCH segment may be configured by RBs included in the first DL subband among RBs included in the scheduled PDSCH, and the second PDSCH segment may be configured by RBs included in the second DL subband among RBs included in the scheduled PDSCH. If the RBs of the scheduled PDSCH are included in one DL subband (hereinafter, referred to as first DL subband) only and are not included in the other DL subband (hereinafter, referred to as second DL subband), the condition regarding the second PDSCH segment may be ignored. For example, if RBs included in the first PDSCH segment are consecutive in the frequency domain, and if the number of RBs included in the PDSCH is larger than Y1, the UE may determine that the PRG granularity value is “wideband.” Otherwise, the UE may determine that the PRG granularity value is “narrowband.”
In the first to third conditions, Y1 may be at least one of N_BWP, N_SB1, min{N_SB1,N_SB2}, max{N_SB1,N_SB2}, N_SB1+N_SB2, (N_SB1+N_SB2)/2, or a value configured by the gNB. Alternatively, Y1 may be the larger value between X and at least one of N_BWP, N_SB1, min{N_SB1,N_SB2}, max{N_SB1,N_SB2}, N_SB1+N_SB2, (N_SB1+N_SB2)/2, or a value configured by the gNB. Y2 may be at least one of N_BWP, N_SB2, min{N_SB1,N_SB2}, max{N_SB1,N_SB2}, N_SB1+N_SB2, (N_SB1+N_SB2)/2, or a value configured by the gNB. Alternatively, Y2 may be the larger value between X and at least one of N_BWP, N_SB2, min{N_SB1,N_SB2}, max{N_SB1,N_SB2}, N_SB1+N_SB2, (N_SB1+N_SB2)/2, or a value configured by the gNB. X may be a value configured by the gNB.

Fourth step 1540: the UE may receive a PDSCH according to the determined PRG granularity. For example, in case that the PRG granularity is deemed to be “wideband,” the UE may assume that DMRSs of all RBs of the PDSCH segment have been transmitted through the same precoder. In case that the PRG granularity is deemed to be “narrowband,” the UE may assume that DMRSs of two (in case that n2-wideband has been configured) or four (in case that n4-wideband has been configured) consecutive RBs of the PDSCH segment have been transmitted through the same precoder.

As another example of the disclosure, the DCI format received by the UE may include on one-bit PRB bundling size indicator field (or zero-bit PRB bundling size indicator field). The UE may determine the PRG granularity according to scheduling information, regardless of the DCI format's indication.

More specifically, the UE may receive a BundleSize-related configuration from the gNB. BundleSizeSet1 may include at least one value among {n2, n4, wideband, n2-wideband, n4-wideband}. For example, in case that BundleSizeSet1 includes n2-wideband or n4-wideband, the UE may determine that two values are included, such as {n2, wideband} or {n4, wideband}. Thereafter, it may be described hereinafter in the disclosure that, in case that BundleSizeSet1 includes n2-wideband or n4-wideband, BundleSizeSet1 includes two values. The UE may have no bundleSizeSet2 configured therefor by the gNB.

The UE may determine that one or two values (n2-wideband, n4-wideband) included in BundleSizeSet1 are dynamic PRG granularity values. In case that BundleSizeSet1 includes one value (n2, n4, or wideband), the UE may determine that the one value is a dynamic PRG granularity value. In case that BundleSizeSet1 includes two values (n2-wideband, n4-wideband), the UE may select one of the two values and may determine the same as a PRG granularity value. The UE may select one of the two values as follows:

As an example, if a PDSCH is scheduled for one DL subband, the same is continuous in the frequency domain, and the number of scheduled RBs is larger than half the number of RBs included in the DL subband, the UE may determine that the PRG granularity value is “wideband.” In case that the above-described condition is not satisfied (for example, in case that the PDSCH is scheduled for two DL subbands, or the same is discontinuous in the frequency domain, or the number of scheduled RBs is smaller than or equal to half the number of RBs included in the DL subband), the UE may determine that the PRG granularity value is n2 (BundleSizeSet1 includes n2-wideband as two values) or n4 (BundleSizeSet1 includes n4-wideband as two values).

An upper layer signal according to the disclosure may be given in Table 17 below:

TABLE 17
PDSCH-Config ::= SEQUENCE {
prb-BundlingType CHOICE {
staticBundling SEQUENCE {
bundleSize ENUMERATED { n4, wideband } OPTIONAL -- Need S
},
dynamicBundling SEQUENCE {
bundleSizeSet1 ENUMERATED { n4, wideband, n2-wideband, n4-wideband } OPTIONAL, -
- Need S
bundleSizeSet2 ENUMERATED { n4, wideband } OPTIONAL -- Need S
}
},
}

According to the disclosure, the length of the PRB bundling size indicator field in the DCI format may be determined according to whether bundleSizeSet2 is configured or not. For example, in case that bundleSizeSet2 is not configured, the PRB bundling size indicator field may have zero-bit length. In addition, regardless of the DCI format's indication, the UE may determine, according to BundleSizeSet1, that the narrowband value is n2 (BundleSizeSet1 includes n2-wideband as two values) or n4 (BundleSizeSet1 includes n4-wideband as two values), or may determine that the wideband value is “wideband.” Table 18 may indicate the length of the PRB bundling size indicator field according to the disclosure.

TABLE 18
PRB bundling size indicator - 0 bit if the higher layer parameter prb-BundlingType is
not configured or is set to “staticBundling” or bundleSizeSet2 is not configured, or 1
bit if the higher layer parameter prb-BundlingType is set to “dynamicBundling” and
bundleSizeSet2 is configured according to Clause 5.1.2.3 of [6, TS 38.214].

According to an embodiment of the disclosure, the length of the PRB bundling size indicator field in the DCI format may be configured by a separate upper layer signal. For example, the UE may determine the length of the PRB bundling size indicator field, based on a separate upper layer signal. For example, the UE may receive upper layer signal which indicates zero bit or one bit as the length of the PRB bundling size indicator field from the gNB.

In another method, an upper layer signal according to the disclosure may be given in Table 19. In this regard, instead of the above-described bundleSizeSet2 in dynamicBundling, new bundleSize-v19 may be introduced in staticBundling, and the bundleSize-v19 may indicate one value among n4, wideband, n2-wideband, and n4-wideband.

The UE may determine that one or two values (n2-wideband, n4-wideband) included in bundleSize-v19 are PRG granularity values. If bundleSize-v19 includes one value (n2, n4, or wideband), the UE may determine that the one value is a dynamic PRG granularity value. If bundleSize-v19 includes two values (n2-wideband, n4-wideband), the UE may select one of the two values and determine that the selected value is a PRG granularity value. The PRB bundling size indicator may be zero bit because of staticBundling.

TABLE 19
PDSCH-Config ::= SEQUENCE {
prb-BundlingType CHOICE {
staticBundling SEQUENCE {
bundleSize ENUMERATED { n4, wideband } OPTIONAL -- Need S
bundleSize-v19 ENUMERATED { n4, wideband, n2-wideband, n4-wideband } OPTIONAL --
Need S
},
dynamicBundling SEQUENCE {
bundleSizeSet1 ENUMERATED { n4, wideband, n2-wideband, n4-wideband } OPTIONAL, -
- Need S
bundleSizeSet2 ENUMERATED { n4, wideband } OPTIONAL -- Need S
}
},
}

In another method, an upper layer signal according to the disclosure may be given in Table 20. In this regard, instead of the above-described bundleSizeSet2 in dynamicBundling, new bundleSize-v19 may be introduced in staticBundling. In addition, the bundleSize-v19 may indicate one value among n2-wideband and n4-wideband.

The UE may determine that one or two values (n2-wideband, n4-wideband) included in bundleSize-v19 are PRG granularity values. If bundleSize-v19 is not configured, the UE may determine that the one value (n2, n4, or wideband) in bundleSize is a PRG granularity value. If bundleSize-v19 is configured, the UE may select one of two values configured for bundleSize-v19 and determine that the selected value is a PRG granularity value. The PRB bundling size indicator may be zero bit because of staticBundling.

TABLE 20
PDSCH-Config ::= SEQUENCE {
prb-BundlingType CHOICE {
staticBundling SEQUENCE {
bundleSize ENUMERATED { n4, wideband } OPTIONAL -- Need S
bundleSize-v19 ENUMERATED { n2-wideband, n4-wideband } OPTIONAL -- Need S
},
dynamicBundling SEQUENCE {
bundleSizeSet1 ENUMERATED { n4, wideband, n2-wideband, n4-wideband } OPTIONAL, -
- Need S
bundleSizeSet2 ENUMERATED { n4, wideband } OPTIONAL -- Need S
}
},
}

In another method, in case that staticBundling and bundleSize are configured as “wideband,” the UE may determine the PRG granularity in an SBFD symbol according to the following condition. If all PRBs scheduled for a PDSCH are consecutive in the frequency domain, the UE may determine that the PRG granularity is “wideband.” Alternatively, if PRBs scheduled for a PDSCH are nonconsecutive in the frequency domain, the UE may determine that the PRG granularity is “n2” which is a narrowband value. According to the above-described method, the UE may determine the PRG granularity without a separate signal. The above-described method may be applied to SBFD symbols only and may not be applied to non-SBFD symbols. For example, in case that a PDSCH is scheduled for a non-SBFD symbol, the UE may expect that the PDSCH may always include PRBs that are consecutive in the frequency domain. Otherwise, the UE may ignore or discard the DCI that schedules the PDSCH. Alternatively, the above-described method may be equally applied to SBFD symbols and non-SBFD symbols. Alternatively, the above-described method may be applied to a specific DCI format only. For example, in case that a PDSCH is scheduled by DCI format 1_0, the UE may expect that the PDSCH may include PRBs that are consecutive in the frequency domain. Otherwise (for example, in case that the PDSCH is not scheduled by DCI format 1_0), the UE may ignore or discard the DCI that schedules the PDSCH. In case that a PDSCH is scheduled by DCI format 1_1, the UE may determine “wideband” if the PDSCH includes PRBs that are consecutive in the frequency domain. Alternatively, if the PDSCH includes PRBs that are nonconsecutive in the frequency domain, the UE may determine “n2” which is a narrowband value. Alternatively, the gNB may indicate the DCI format to which the above-described method is applied, to the UE. For example, in the case of a PDSCH scheduled by a DCI format that is to be indicated, the UE may determine “wideband” if the PDSCH includes PRBs that are consecutive in the frequency domain, and may determine “n2” which is a narrowband value. in the case of a PDSCH scheduled by a DCI format that is not indicated, the UE may expect that the PDSCH may include PRBs that are consecutive in the frequency domain. Otherwise, the UE may ignore or discard the DCI that schedules the PDSCH. The indication may be determined based on the value of the DCI field included in the DCI format. Alternatively, the indication may be configured by the DCI format (DCI format 1_0, 1_1, 1_2, or the like) through an upper layer signal.

In the above-described embodiment, the UE may apply different PRG granularity determination methods to a PDSCH scheduled for a non-SBFD symbol and to a PDSCH scheduled for an SBFD symbol, respectively. According to another method, the UE may apply the same PRG granularity determination method to a PDSCH scheduled for a non-SBFD symbol and to a PDSCH scheduled for an SBFD symbol.

Step 0: the UE may receive a DCI format that schedules a PDSCH. The DCI format may include a TDRA field that indicates symbols for which the PDSCH is scheduled, and an FDRA field that indicates scheduled RBs. The UE may determine symbols and RBs, for which the PDSCH is scheduled, through the TDRA field and the FDRA field.

Step 1: the UE may acquire a one-bit PRB bundling size indicator field from the DCI format. If the field has a value of “0,” the UE may determine the PRG granularity value, based on one value configured in BundleSizeSet2. If the field has a value of “1,” the UE may determine the PRG granularity value, based on one or two values configured in BundleSizeSet1. If one value is configured in BundleSizeSet1, the UE may determine the PRG granularity value, based on one value. If two values are configured in BundleSizeSet1, the UE may determine the PRG granularity value, based on one of the two values. One of the two values may be determined in the second step.

Step 2: the PRG granularity value may be determined according to at least one of the following conditions. Obviously, the following example is not limitative.
The UE may identify whether RBs included in a scheduled PDSCH are consecutive in the frequency domain. The UE may determine whether RBs included in a scheduled PDSCH are divided into a maximum of two consecutive PDSCH segments (first and second PDSCH segments). For example, if all RBs included in the PDSCH are consecutive in the frequency domain, the UE may determine that all RBS are included in the first PDSCH segment. If RBs included in the PDSCH are configured by first RBs {RB x, RB x+1, . . . , RB x+N−1} and second RBs {RB y, RB y+1, . . . , RB y+M−1} which are consecutive in the frequency domain, the UE may determine that the first RBs are included in the first PDSCH segment, and the second RBs are included in the second PDSCH segment.
In case that RBs included in a scheduled PDSCH are not divided into a maximum of two PDSCH segments that are consecutive in the frequency domain, the UE may determine that the PRG granularity value is “narrowband.” Alternatively, in case that RBs included in the scheduled PDSCH are nonconsecutive in the frequency domain, the UE may determine that the PRG granularity value is “narrowband.”
In case that RBs included in a scheduled PDSCH are divided into a maximum of two PDSCH segments that are consecutive in the frequency domain, the UE may determine the PRG granularity as follows. Alternatively, in case that RBs included in a scheduled PDSCH are consecutive in the frequency domain, the UE may determine the PRG granularity as follows. In this case, the UE may apply the following conditions based on an assumption that the consecutive PRBs are included in the first PDSCH segment.
First condition: if the number of RBs included in the first PDSCH segment is larger than Y1, and the number of RBs included in the second PDSCH segment is larger than Y2, the UE may determine that the PRG granularity value is “wideband.” Otherwise, the UE may determine that the PRG granularity value is “narrowband.” If RBs of the scheduled PDSCH is included in the first PDSCH segment only, conditions regarding the second PDSCH segment may be ignored.
Second condition: if the number of RBs included in the first PDSCH segment is larger than Y1, or the number of RBs included in the second PDSCH segment is larger than Y2, the UE may determine that the PRG granularity value is “wideband.” Otherwise, the UE may determine that the PRG granularity value is “narrowband.”
Third condition: if the number of all RBs ranging from the starting RB of RBs included in the first PDSCH segment to the last RB of RBs included in the second PDSCH is larger than Y, the UE may determine that the PRG granularity value is “wideband.” Otherwise, the UE may determine that the PRG granularity value is “narrowband.”
In connection with the first to third conditions, if RBs of the scheduled PDSCH are included in the first PDSCH segment only, conditions regarding the second PDSCH segment may be ignored. For example, if the number of RBs included in the first PDSCH segment is larger than Y1, the UE may determine that the PRG granularity value is “wideband.” Otherwise, the UE may determine that the PRG granularity value is “narrowband.”
In this regard, Y1 may be at least one of N_BWP, N_SB1, min{N_SB1,N_SB2}, max{N_SB1,N_SB2}, N_SB1+N_SB2, (N_SB1+N_SB2)/2, or a value configured by the gNB. Alternatively, Y1 may be the larger value between X and at least one of N_BWP, N_SB1, min{N_SB1,N_SB2}, max{N_SB1,N_SB2}, N_SB1+N_SB2, (N_SB1+N_SB2)/2, or a value configured by the gNB. Y2 may be at least one of N_BWP, N_SB2, min{N_SB1,N_SB2}, max{N_SB1,N_SB2}, N_SB1+N_SB2, (N_SB1+N_SB2)/2, or a value configured by the gNB. Alternatively, Y2 may be the larger value between X and at least one of N_BWP, N_SB2, min{N_SB1,N_SB2}, max{N_SB1,N_SB2}, N_SB1+N_SB2, (N_SB1+N_SB2)/2, or a value configured by the gNB. X may be a value configured by the gNB.

Step 3: the UE may receive a PDSCH according to the determined PRG granularity. For example, in case that the PRG granularity is deemed to be “wideband,” the UE may assume that DMRSs all RBs of the PDSCH segment have been transmitted through the same precoder. In case that the PRG granularity is deemed to be “narrowband,” the UE may assume that DMRSs of two (in case that n2-wideband has been configured) or four (in case that n4-wideband has been configured) consecutive RBs of the PDSCH segment have been transmitted through the same precoder.

The UE may determine the PRG granularity, based on a maximum of two PDSCH segments, according to the above-described method. In another method, the UE may receive a PDSCH as follows:

Step 0: the UE may receive a DCI format that schedules a PDSCH. The DCI format may include a TDRA field that indicates symbols for which the PDSCH is scheduled, and an FDRA field that indicates scheduled RBs. The UE may determine symbols and RBs, for which the PDSCH is scheduled, through the TDRA field and the FDRA field.

Step 1: the UE may acquire a one-bit PRB bundling size indicator field from the DCI format. If the field has a value of “0,” the UE may determine the PRG granularity value, based on one value configured in BundleSizeSet2. If the field has a value of “1,” the UE may determine the PRG granularity value, based on one or two values configured in BundleSizeSet1. If one value is configured in BundleSizeSet1, the UE may determine the PRG granularity value, based on one value. If two values are configured in BundleSizeSet1, the UE may determine the PRG granularity value, based on one of the two values. One of the two values may be determined in the second step.

Step 2: the PRG granularity value may be determined according to at least one of the following conditions. Obviously, the following example is not limitative.
The UE may identify whether RBs included in a scheduled PDSCH are consecutive in the frequency domain. The UE may determine whether RBs included in a scheduled PDSCH are consecutive in the frequency domain.
In case that RBs included in the scheduled PDSCH are nonconsecutive in the frequency domain, the UE may determine that the PRG granularity value is “narrowband.”
In case that RBs included in the scheduled PDSCH are consecutive in the frequency domain, the UE may determine the PRG granularity as follows.
If the number of RBs included in the PDSCH is larger than Y, the UE may determine that the PRG granularity value is “wideband.” Otherwise, the UE may determine that the PRG granularity value is “narrowband.”
In this regard, Y may be at least one of N_BWP/2, N_SB1/2, min{N_SB1,N_SB2}/2, max{N_SB1,N_SB2}/2, N_SB1+N_SB2, (N_SB1+N_SB2)/2, (N_SB1+N_SB2)/4, or a value configured by the gNB. Alternatively, Y1 may be the larger value between X and at least one of N_BWP/2, N_SB1/2, min{N_SB1,N_SB2}/2, max{N_SB1,N_SB2}/2, N_SB1+N_SB2, (N_SB1+N_SB2)/2, (N_SB1+N_SB2)/4, or a value configured by the gNB. For reference, in case that the PDSCH is scheduled for the first DL subband only, Y may be N_SB1/2. N_SB1 may be the number of RBs included in first DL subband. In case that the PDSCH is scheduled for the second DL subband only, Y may be N_SB2/2. N_SB2 may be the number of RBs included in second DL subband.

Step 3: the UE may receive a PDSCH according to the determined PRG granularity. For example, in case that the PRG granularity is deemed to be “wideband,” the UE may assume that DMRSs all RBs of the PDSCH segment have been transmitted through the same precoder. In case that the PRG granularity is deemed to be “narrowband,” the UE may assume that DMRSs of two (in case that n2-wideband has been configured) or four (in case that n4-wideband has been configured) consecutive RBs of the PDSCH segment have been transmitted through the same precoder.

### [Embodiment: PDSCH Repetition or SPS Configuration]

The UE may receive DCI that schedules PDSCH repeated transmission from the gNB. In addition, the UE may receive DCI that indicates SPS activation from the gNB. The above-described two pieces of DCI may schedule multiple PDSCH reception occasions.

For example, the DCI that schedules PDSCH repeated transmission may schedule a PDSCH that schedules the same transport block (TB) in N consecutive slots, starting from the scheduled slot (including the scheduled slot). In this regard, the number of consecutive symbols and starting symbols used for PDSCH reception in each slot may be identical. In this regard, symbols used for PDSCH reception in each slot may be referred to as PDSCH reception occasions.

For example, the DCI that indicates SPS activation may schedule a PDSCH that schedules a transport block (TB) for every P slots, starting from the scheduled slot (including the scheduled slot). In this regard, P may be a value corresponding to the SPS configuration's periodicity. In the slot that appears for every P slots, the number of consecutive symbols and starting symbols used for SPS PDSCH reception may be identical. In this regard, symbols used for SPS PDSCH reception in each slot may be referred to as PDSCH reception occasions.

The following description may be based on DCI that schedules PDSCH repeated transmission unless specified otherwise. However, the same embodiment may be applied in connection with DCI that indicates SPS activation.

In the disclosure, a method for determining the PRG granularity of a PDSCH in case that some of PDSCH reception occasions overlap a non-SBFD symbol, and some other PDSCH reception occasions overlap an SBFD symbol.

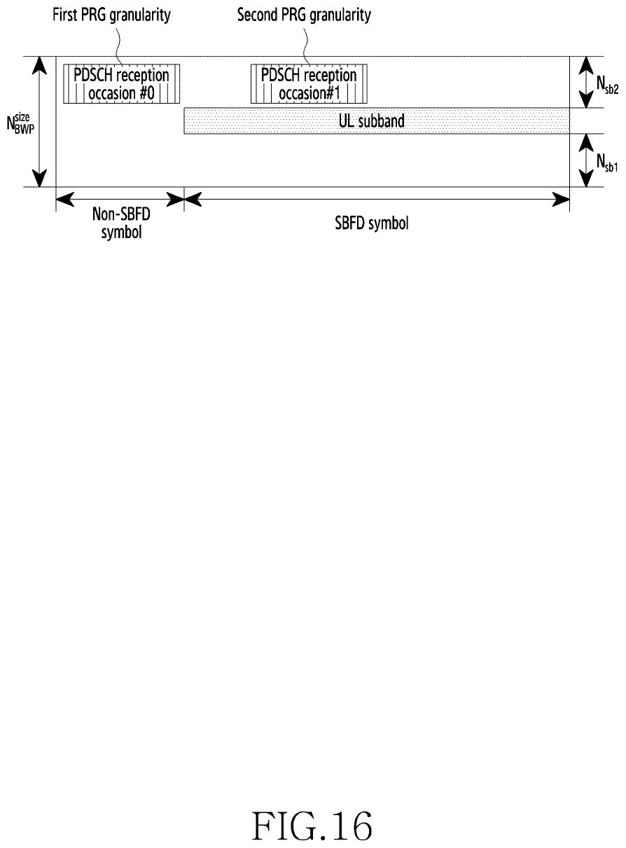

FIG. 16 illustrates scheduled PDSCH repeated reception and a precoder assumption in an SBFD system according to an embodiment of the disclosure. Specifically, PDSCH reception occasions of PDSCH repeated reception may be described.

Referring to FIG. 16, PDSCH reception occasion #0 may overlap a non-SBFD symbol, and PDSCH reception occasion #1 may overlap an SBFD symbol. For reference, PDSCH reception occasion #1 may overlap only one DL subband or may overlap two DL subbands. The method disclosed hereinafter may be applied both to a case in which PDSCH reception occasion #1 overlaps only one DL subband and to a case in which PDSCH reception occasion #1 overlaps two DL subbands.

Referring to FIG. 16, a method in which the UE determines the first PRG granularity for the PDSCH received in the non-SBFD symbol and determines the second PRG granularity for the PDSCH received in the SBFD symbol, is disclosed. Depending on the embodiment, the first PRG granularity and the second PRG granularity may be identical to or different from each other.

The DCI that schedules PDSCH repeated transmission may include a one-bit bundling size indicator field. Through the next embodiment, the UE may determine the PRG granularity of a PDSCH reception occasion that overlaps a non-SBFD symbol and the PRG granularity of a PDSCH reception occasion that overlaps an SBFD symbol. For reference, the PRG granularity of PDSCH reception occasions may be determined by the method in at least one of the above-described first to third embodiments.

In the fourth embodiment of the disclosure, one bit of the DCI that schedules PDSCH repeated transmission may be separately applied to each symbol type. In other words, the PRG granularity may be determined separately in each symbol type. For example, in the case of a PDSCH reception occasion that overlaps non-SBFD symbols, the first PRG granularity may be determined based on the BWP size-based determination method. In the case of a PDSCH reception occasion that overlaps SBFD symbols, the second PRG granularity may be determined based on at least one of the first to third embodiments. When the UE receives a PDSCH in a PDSCH reception occasion that overlaps non-SBFD symbols, the UE may receive the PDSCH according to the first PRG granularity. When the UE receives a PDSCH in a PDSCH reception occasion that overlaps SBFD symbols, the UE may receive the PDSCH according to the second PRG granularity. For example, in each reception occasion, the PRG granularity may be one of the first PRG granularity or the second PRG granularity.

A method for determining the same PRG granularity for two symbol types may be added to the fourth embodiment of the disclosure. According to the fourth embodiment described above, the UE may determine a first PRG granularity and a second PRG granularity, and the granularities may differ from each other. If the granularities differ from each other, they may be changed to the same granularity through the following process:

If at least one of the first PRG granularity and the second PRG granularity is “narrowband,” the UE may change both the first PRG granularity and the second PRG granularity to “narrowband.” For example, if the first PRG granularity is “narrowband,” and the second PRG granularity is “wideband,” the UE may change the second PRG granularity to “narrowband” which is identical to the first PRG granularity. Through this process, the PRG granularity of all PDSCH reception occasions may be identically used.

In the fifth embodiment of the disclosure, one bit of the DCI that schedules PDSCH repeated transmission may be applied to only one symbol type. In addition, one bit of the DCI and the PRG granularity determined according to one symbol type may also be applied to other symbol types. In this regard, one symbol type may be determined by at least one of the following methods. Obviously, the following example is not limitative.

Fifth method: the UE may determine the PRG granularity by always applying one bit to a non-SBFD symbol type. For example, the UE may determine the PRG granularity by using the BWP size-based determination method with regard to a PDSCH that overlaps a non-SBFD symbol. The PRG granularity may be applied to an SBFD symbol type.

Sixth method: the UE may determine the PRG granularity by always applying one bit to an SBFD symbol type. For example, the UE may determine the PRG granularity by using the method in the first, second, or third embodiment described above with regard to a PDSCH that overlaps an SBFD symbol. The PRG granularity may be applied to a non-SBFD symbol type.

Seventh method: the UE may determine one symbol type, based on scheduling information. For example, the UE may determine that a symbol type for which the first PDSCH reception occasion of scheduled PDSCH repetition is scheduled is one symbol type. For example, if the symbol type for which the first PDSCH reception occasion is scheduled is a non-SBFD symbol type, the fifth method may be applied. If the symbol type for which the first PDSCH reception occasion is scheduled is an SBFD symbol type, the sixth method may be applied.

When the PRG granularity determined for one symbol type by the UE is applied to another symbol type, the UE may determine whether the same can be applied or not. For example, in case that the PRG granularity is deemed to be “wideband” with regard to a non-SBFD symbol type, and the determined value is applied to an SBFD symbol type, the UE may determine whether the wideband is applicable, based on the above-described specific condition. For example, if the above-described specific condition is satisfied, the wideband may be applied. Otherwise, the narrowband value (for example, n2 if n2-wideband, or n4 if n4-wideband, or n2 regardless of the value configured for the UE) may be used.

In the sixth embodiment of the disclosure, one bit of the DCI that schedules PDSCH repeated transmission may be separately applied to each of two symbol types, and separate BundleSizeSet1 or BundleSizeSet2 may be configured for each symbol type. More specifically, existing BundleSizeSet1 and BundleSizeSet2 may be configurations for non-SBFD symbols, and the UE may have BundleSizeSet1-SBFD and BundleSizeSet2-SBFD configured additionally for SBFD symbols. In this case, BundleSizeSet1-SBFD may be configured as one value among {n2, n4, wideband, n2-wideband, n4-wideband}, and BundleSizeSet2-SBFD may be configured as one value among {n2, n4, wideband}. When determining the PRG granularity of a PDSCH reception occasion that overlaps a non-SBFD symbol, the UE may determine the first PRG granularity, based on one bit and BundleSizeSet1 and BundleSizeSet2. When determining the PRG granularity of a PDSCH reception occasion that overlaps an SBFD symbol, the UE may determine the second PRG granularity, based on one bit and BundleSizeSet1-SBFD and BundleSizeSet2-SBFD.

In the seventh embodiment of the disclosure, one bit of the DCI that schedules PDSCH repeated transmission may be applied to only one symbol type. In addition, a default value may always be applied to another symbol type. For example, the UE may determine the PRG granularity by always applying one bit to a non-SBFD symbol type. For example, the UE may determine the PRG granularity by using the BWP size-based determination method with regard to a PDSCH that overlaps a non-SBFD symbol. The PRG granularity may be applied to an SBFD symbol type. The UE may use a narrowband value (for example, n2 if n2-wideband, or n4 if n4-wideband, or n2 regardless of the value configured for the UE), as the default value, for the SBFD symbol type.

In the above-described embodiments, the DCI may include one-bit PRB bundling size indicator field. According to a method, the DCI may include a two-bit PRB bundling size indicator field. One bit in the two-bit PRB bundling size indicator field may be a value corresponding to a first symbol type (non-SBFD symbol), and the other one bit may a value corresponding to a second symbol type (SBFD symbol). For example, different values may be indicated to different symbol types.

### [Embodiment: Semi-Static PRG Granularity]

The UE may be configured (prb-BundlingType=staticBundling) by the gNB so as to statically determine the PRG granularity. For static PRG granularity determination, the UE may receive an upper layer signal (bundleSize) from the gNB. One value among {n2, n4, wideband} may be configured as the bundleSize.

In the above-described embodiment, the UE may apply an identically configured bundleSize to a non-SBFD symbol and an SBFD symbol. In an embodiment of the disclosure, the UE may have two bundleSizes configured therefor, in order to configure the PRG granularity to be used for a non-SBFD symbol and an SBFD symbol. The existing bundleSize may be applied to a PDSCH scheduled for a non-SBFD symbol, and a newly configured bundleSize may be applied to a PDSCH scheduled for an SBFD symbol. For example, different PRG granularities may be applied to the non-SBFD symbol and the SBFD symbol. For example, the PRG granularity of the non-SBFD symbol may be configured to be bundleSize=wideband, and the PRG granularity of the SBFD symbol may be configured to be bundleSize=n2. In this case, the PRG granularity of the PDSCH scheduled for the non-SBFD symbol may be “wideband,” and the PRG granularity of the PDSCH scheduled for the SBFD symbol may be n2 (narrowband).

In the case of PDSCH reception, the UE may apply a separate configuration to a symbol type. In other words, the PRG granularity may be determined separately through the bundleSize or bundleSize-SBFD with regard to each symbol type. For example, in the case of a PDSCH reception occasion that overlaps non-SBFD symbols, the UE may determine the first PRG granularity according to the value configured in the bundleSize. In the case of a PDSCH reception occasion that overlaps SBFD symbols, the UE may determine the second PRG granularity according to the value configured in the bundleSize-SBFD. When receiving a PDSCH in the PDSCH reception occasion that overlaps non-SBFD symbols, the UE may receive the PDSCH according to the first PRG granularity. When receiving a PDSCH in the PDSCH reception occasion that overlaps SBFD symbols, the UE may receive the PDSCH according to the second PRG granularity. For example, with regard to each reception occasion, the PRG granularity may be one of the first PRG granularity or the second PRG granularity.

A method in which the UE determines the same PRG granularity for two symbol types may be added. According to the above-described embodiment, the UE may determine a first PRG granularity and a second PRG granularity, and the granularities may differ from each other. If the granularities differ from each other, they may be changed to the same granularity through the following process:

If at least one of the first PRG granularity and the second PRG granularity is “narrowband,” the UE may change both the first PRG granularity and the second PRG granularity to “narrowband.” For example, if the first PRG granularity is “narrowband,” and the second PRG granularity is “wideband,” the UE may change the second PRG granularity to “narrowband” which is identical to the first PRG granularity. Through this process, the PRG granularity of all PDSCH reception occasions may be identically used.

In the case of PDSCH reception, the UE may determine the PRG granularity, based on one symbol type. For example, the UE may determine the PRG granularity, based on the configuration of one of bundleSize or bundleSize-SBFD. One symbol type may be determined in the following method:

The UE may always determine the PRG granularity according to bundleSize-SBFD configurations for an SBFD symbol type. The PRG granularity may be applied to a non-SBFD symbol type.

The UE may always determine the PRG granularity according to bundleSize configurations for a non-SBFD symbol type. The PRG granularity may be applied to an SBFD symbol type.

The UE may determine one symbol type, based on scheduling information. For example, the UE may determine that the symbol type for which the first PDSCH reception occasion of scheduled PDSCH repetition is scheduled is one symbol type.

If the PRG granularity of a first symbol type (for example, non-SBFD symbol) is configured to be “wideband,” and if the PRG granularity of a second symbol type (for example, SBFD symbol) is configured to be “narrowband,” the UE may expect that, in the first symbol, RBs that are consecutive in the frequency domain may be scheduled. However, in the second symbol type, no scheduling of RBs that are nonconsecutive in the frequency domain may be allowed. If scheduling information received by the UE schedules RBs that are nonconsecutive in the frequency domain, the UE may receive a PDSCH reception occasion in the second symbol type, but may receive no PDSCH reception occasion in the first symbol type. For example, in the first symbol type, PDSCH reception occasions may be ignored/skipped/dropped.

In an embodiment of the disclosure, in case that the UE has both staticBundling and bundleSize to be “wideband” (for example, an SBFD symbol and a non-SBFD symbol are identically configure), and in case that a PDSCH is repeated received in an SBFD symbol and a non-SBFD symbol, the UE may determine the PRG granularity and whether or not to receive the same as follows:

In the first method, the UE may determine whether a wideband condition is satisfied in each symbol type. For example, the UE may determine, in a non-SBFD symbol, whether PRBs for which a PDSCH is scheduled are consecutive in the frequency domain. In addition, the UE may determine, in an SBFD symbol, whether PRBs for which a PDSCH is scheduled are consecutive in the frequency domain. If the determination is satisfied in both symbol types, the UE may receive a PDSCH in both symbol types, based on a wideband PRG. If the determination is not satisfied in at least one symbol type, the UE may determine that the PDSCH-scheduling DCI is wrong information, and may ignore or discard the DCI.

In the second method, the UE may determine whether the wideband condition is satisfied in each symbol type. For example, the UE may determine, in a non-SBFD symbol, whether PRBs for which a PDSCH is scheduled are consecutive in the frequency domain. In addition, the UE may determine, in an SBFD symbol, whether PRBs for which a PDSCH is scheduled are consecutive in the frequency domain. If the determination is satisfied in both symbol types, the UE may receive a PDSCH in both symbol types, based on a wideband PRG. If the determination is not satisfied in one symbol type, the UE may not receive a PDSCH in the unsatisfying symbol type, and may receive a PDSCH in the satisfying symbol type only, based on the wideband PRG. If the determination is not satisfied in both symbol types, the UE may determine that the PDSCH-scheduling DCI is wrong information, and may ignore or discard the DCI.

In the third method, the UE may determine whether the wideband condition is satisfied in each symbol type. For example, the UE may determine, in a non-SBFD symbol, whether PRBs for which a PDSCH is scheduled are consecutive in the frequency domain. In addition, the UE may determine, in an SBFD symbol, whether PRBs for which a PDSCH is scheduled are consecutive in the frequency domain. If the determination is satisfied in both symbol types, the UE may receive a PDSCH in both symbol types, based on a wideband PRG. If the determination is not satisfied in one symbol type, the UE may receive a PDSCH in the satisfying symbol type, based on the wideband PRG, and may receive a PDSCH in the unsatisfying symbol type, based on a narrowband value of “n2.”

In the fourth method, the UE may determine whether the wideband condition is satisfied in each symbol type. For example, the UE may determine, in a non-SBFD symbol, whether PRBs for which a PDSCH is scheduled are consecutive in the frequency domain. In addition, the UE may determine, in an SBFD symbol, whether PRBs for which a PDSCH is scheduled are consecutive in the frequency domain. If the determination is satisfied in both symbol types, the UE may receive a PDSCH in both symbol types, based on a wideband PRG. If the determination is not satisfied in at least one symbol type, the UE may receive a PDSCH in both symbol types, based on a narrowband value of “n2.”

The above-described case in which the UE repeatedly receives a PDSCH in an SBFD symbol and in a non-SBFD symbol may include at least one from among repeated reception of a PDSCH scheduled by one piece of DCI, SPS PDSCH reception, or reception of multiple PDSCH.

As another example, the UE may have a PDSCH scheduled by PRBs (for example, first PRB set) that are consecutive in the frequency domain in a non-SBFD symbol, but nonconsecutive PRBs (for example, second PRB set) may be included in the PDSCH in an SBFD symbol. In this case, the second PRB set may include only RBs that are included in DL subbands in the first PRB set, and two DL subbands may be positioned at different locations in the frequency domain. Therefore, the UE may find that the wideband condition is satisfied in the non-SBFD symbol, but the wideband condition may not be satisfied in the SBFD symbol. In this case, the second PRB set for which the PDSCH is scheduled in the SBFD symbol may include two consecutive PRBs. The (2-1)^{th} PRB set may be PRBs included in the first DL subband among the first PRB set, and the (2-2)^{th} PRB set may be PRBs included in the second DL subband among the first PRB set. The union of the (2-1)^{th} PRB set and the (2-2)^{th} PRB set is the second PRB set. According to the disclosure, the UE may assume that a PDSCH has been scheduled by one of the (2-1)^{th} PRB set or the (2-2)^{th} PRB set in the SBFD symbol, thereby receiving the PDSCH, based on the wideband PRB condition. One of the (2-1)^{th} PRB set or the (2-2)^{th} PRB set may be selected by at least one of the following methods:

In the first method, the UE may always select a PRB set corresponding to a low DL subband in the frequency domain.

In the second method, the UE may select a PRB set including the larger number or PRBs between the (2-1)^{th} PRB set and the (2-2)^{th} PRB set.

In the third method, the UE may be configured to select one DL subband according to an upper layer signal.

In the fourth method, the UE may select one DL subband according to a DCI format. One DL subband may be selected according to the value of the DCI field included in the DCI format.

In the fifth method, the UE may select one DL subband, based on the index of a slot corresponding to a PDSCH, the index of the starting/last symbol of the PDSCH, a PDSCH repetition index (for example, in the case of PDSCH repetition, the first PDSCH's repetition index is labeled 0, and the second PDSCH's repetition index is labeled 1), or the PDSCH's HARQ process number. For example, the UE may select the first DL subband if the index is I, and if I mod 2=0. Alternatively, the UE may select the second DL subband if I mod 2=1.

### [Embodiment 2: TCI State]

The UE may have repeated reception configured in the frequency domain according to the gNB's configuration. For example, in case that the gNB configures repetitionScheme to be fdmSchemeA or fdmSchemeB for the UE, the UE may have two TCI states indicated thereto, and may receive a PDSCH according to the following operations:
In case that “fdmSchemeA” is configured for the UE, the UE may need to receive a single PDSCH transmission occasion having one TB. Two TCI states may correspond to the single PDSCH transmission occasion, and respective TCI states may not overlap in the frequency domain for which the PDSCH is scheduled.
In case that “fdmSchemeB” is configured for the UE, the UE may need to receive two PDSCH transmission occasions having one TB. Respective PDSCH transmission occasions may not overlap in the frequency domain, and respective PDSCH transmission occasions may correspond to respective TCI states.

In addition, the UE may have a joint TCI state list (dl-OrJointTCI-StateList) configured therefor by the gNB, and the UE may have two TCI states indicated from the list.

In the disclosure, in case that the UE receives two TCI states as described above, the UE may determine PRBs (first PRB set) corresponding to the first TCI state and PRBs (second PRB set) corresponding to the second TCI state. Legacy determination methods may be as follows:
In case that “wideband” is configured as the PRG granularity for the UE, the first PRB set may include as many first (low in the frequency domain) PRBs as ┌n_{PRB}/2┐, and the second PRB set may include as many remaining PRBs as ┌n_{PRB}/2┐. In this regard, n_{PRB} may indicate the number of PRBs included in the PDSCH scheduled for the UE.
In case that n2 or n4 (narrowband) is configured as the PRG granularity for the UE, the first PRB set may include even-numbered PRGs, and the second PRB set may include odd-numbered PRGs. The index of PRGs may start from 0 in ascending order in the frequency domain.

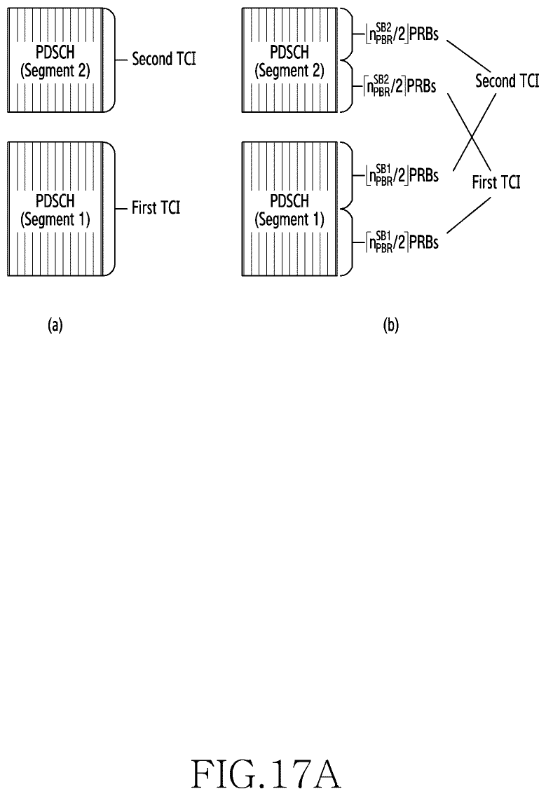

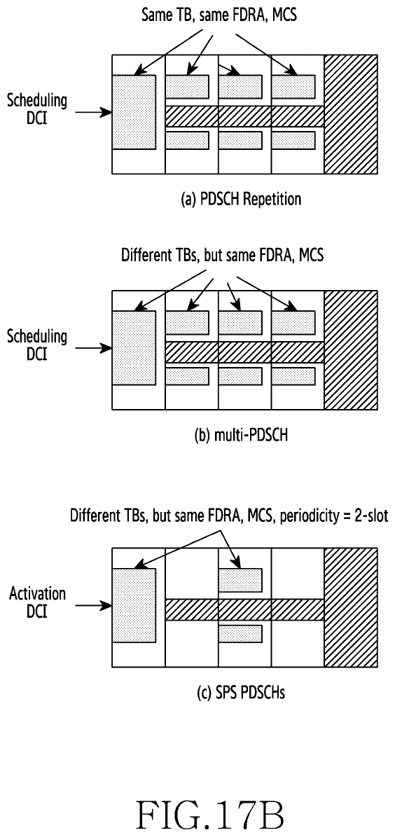

In the disclosure, a method for determining a first PRB set and a second PRB in case that the UE has a PDSCH scheduled across two DL subbands in an SBFD symbol, is disclosed. FIG. 17A (e.g., (a) and (b) as illustrated in FIG. 17A) illustrates two TCI states in a wireless communication system according to an embodiment of the disclosure. Specifically, FIG. 17A (e.g., (a) and (b) as illustrated in FIG. 17A) illustrates a relationship in which PRBs are included.

In an embodiment, if the UE has “wideband” configured as the PRG granularity, the first PRB set may include PRBs included in a first PDSCH segment included in a first DL subband which is low in the frequency domain, and the second PRB set may include PRBs included in a second PDSCH segment included in a second DL subband which is high in the frequency domain.

Referring to FIG. 17A (e.g., (a) as illustrated in FIG. 17A), the PDSCH (segment 1) may include a first PRB set (all or part) corresponding to a first TCI, and the PDSCH (segment 2) may include a second PRB set (all or part) corresponding to a second TCI.

In an embodiment of the disclosure, if the UE has “wideband” configured as the PRG granularity, the first PRB set may include as many first (low in the frequency domain) PRBs as ┌n_{PRB}^{SB1}/2┐ among PRBs included in a first PDSCH segment included in a first DL subband which is low in the frequency domain, and may include as many first (low in the frequency domain) PRBs as ┌n_{PRB}^{SB2}/2┐ among PRBs included in a second PDSCH segment included in a second DL subband which is high in the frequency domain. The second PRB set may include as many remaining PRBs as └n_{PRB}^{SB1}/2┘ among PRBs included in the first PDSCH segment included in the first DL subband which is low in the frequency domain, and may include as many remaining PRBs as └n_{PRB}^{SB2}/2┘ among PRBs included in the second PDSCH segment included in the second DL subband which is high in the frequency domain. n_{PRB}^{SB1} may be the number of PRBs included in the first PDSCH segment, and n_{PRB}^{SB2} may be the number of PRBs included in the second PDSCH segment.

Referring to FIG. 17A (e.g., (b) as illustrated in FIG. 17), the UE may halve the PDSCH (segment 1) such that the first half (as many PRBs as ┌n_{PRB}^{SB1}/2┐) is included in a first PRB set corresponding to a first TCI state, and the remainder (as many PRBs as └n_{PRB}^{SB2}/2┘) is included in a second PRB set corresponding to a second TCI state. The UE may halve the PDSCH (segment 2) such that the first half (as many PRBs as ┌n_{PRB}^{SB2}/2┐) is included in the first PRB set corresponding to the first TCI state, and the remainder (as many PRBs as └n_{PRB}^{SB2}/2┘) is included in the second PRB set corresponding to the second TCI state.

In an embodiment, if the UE has “narrowband” (n2 or n4) configured as the PRG granularity, the first PRB set may include even-numbered PRGs, and the second PRB set may include odd-numbered PRGs. The index of PRGs may start from 0 in ascending order in the frequency domain with regard to each PDSCH segment. For example, PRBs included in PDSCH segments scheduled for the first DL subband may be categorized into PRGs, and the PRGs may be indexed, starting from 0 in ascending order in the frequency domain. PRBs included in PDSCH segments scheduled for the second DL subband may be categorized into PRGs, and the PRGs may be indexed, starting from 0 in ascending order in the frequency domain. For example, respective PRGs of respective PDSCH segments may be indexed.

If the UE has “wideband” configured as the PRG granularity, the first PRB set may include as many first (low in the frequency domain) PRBs as ┌n_{PRB}/2┐, and the second PRB set may include as many remaining PRBs as └n_{PRB}/2┘. n_{PRB} may indicate the number of PRBs included in the scheduled PDSCH. The UE may expect that the first PDSCH segment included in the first DL subband may include as many PRBs as ┌n_{PRB}/2┐, and the second t PDSCH segment included in the second DL subband may include as many PRBs as └n_{PRB}/2┘. If the above-described condition is not satisfied, the UE may receive no PDSCH.

In an embodiment of the disclosure, the UE may receive additional DMRS configuration information from the gNB. The additional DMRS configuration information may include information that configured enhanced DMRS type 1 use. In case that enhanced DMRS type 1 is configured for the UE, the minimum unit of DMRS transmission in the frequency domain may be deemed to be two RB pairs. In addition, the index of the starting RB of the two RB pairs may indicate an RB spaced apart from CRB0 by an even number. For example, the index of the starting RB may have an even-numbered index on the CRB grid.

In case that the UE does not report special UE capability, it may be expected that RB pairs that satisfy frequency-domain conditions may be scheduled. For example, in case that RBs other than RB pairs are scheduled, the UE may ignore or discard scheduling information.

The UE may report UE capability. The UE capability may include the UE's reception capability even if RB pairs that satisfy frequency-domain conditions are not scheduled. Therefore, after reporting UE capability to the gNB, the UE may receive a PDSCH according to scheduling information even if received scheduling information violates the RB pair condition.

In an embodiment of the disclosure, in case that the UE receives additional DMRS configuration information and does not report special UE capability, the UE may whether to receive a PDSCH according to scheduling information according to the following condition, or to ignore or discard the scheduling information.

In an embodiment of the disclosure, if the UE has “wideband” configured as the PRG granularity, the first PRB set may include PRBs included in a first PDSCH segment included in a first DL subband which is low in the frequency domain, and the second PRB set may include PRBs included in a second PDSCH segment included in a second DL subband which is high in the frequency domain. The number of RBs included in the first PRB set may be a multiple of 2, and the index of the lowest RB of the first PRB set may be an even number of the CRB grid (for example, the lowest RB of the first PRB set has an even-numbered offset from CRB0). The number of RBs included in the second PRB set may be a multiple of 2, and the index of the lowest RB of the second PRB set may be an even number of the CRB grid (for example, the lowest RB of the second PRB set has an even-numbered offset from CRB0).

In an embodiment of the disclosure, if the UE has “wideband” configured as the PRG granularity, the first PRB set may include as many first (low in the frequency domain) PRBs ((1-1)^{th} PRB set) as ┌n_{PRB}^{SB1}/2┐ among PRBs included in a first PDSCH segment included in a first DL subband which is low in the frequency domain, and may include as many first (low in the frequency domain) PRBs ((1-2)^{th} PRB set) as ┌n_{PRB}^{SB2}/2┐ among PRBs included in a second PDSCH segment included in a second DL subband which is high in the frequency domain. The second PRB set may include as many remaining PRBs ((2-1)^{th} PRB set) as └n_{PRB}^{SB2}/2┘ among PRBs included in the first PDSCH segment included in the first DL subband which is low in the frequency domain, and may include as many remaining PRBs ((2-2)^{th} PRB set) as └n_{PRB}^{SB2}/2┘ among PRBs included in the second PDSCH segment included in the second DL subband which is high in the frequency domain. n_{PRB}^{SB1} may be the number of PRBs included in the first PDSCH segment, and n_{PRB}^{SB2} may be the number of PRBs included in the second PDSCH segment. The number of RBs included in the (1-1)^{th} PRB set may be a multiple of 2, and the index of the lowest RB of the (1-1)^{th} PRB set may be an even number of the CRB grid (for example, the lowest RB of the (1-1)^{th} PRB set has an even-numbered offset from CRB0). The number of RBs included in the (1-2)^{th} PRB set may be a multiple of 2, and the index of the lowest RB of the (1-2)^{th} PRB set may be an even number of the CRB grid (for example, the lowest RB of the (1-2)^{th} PRB set has an even-numbered offset from CRB0). The number of RBs included in the (2-1)^{th} PRB set may be a multiple of 2, and the index of the lowest RB of the (2-1)^{th} PRB set may be an even number of the CRB grid (for example, the lowest RB of the (2-1)^{th} PRB set has an even-numbered offset from CRB0). The number of RBs included in the (2-2)^{th} PRB set may be a multiple of 2, and the index of the lowest RB of the (2-2)^{th} PRB set may be an even number of the CRB grid (for example, the lowest RB of the (2-2)^{th} PRB set has an even-numbered offset from CRB0).

In an embodiment of the disclosure, in case that the PRG granularity is n2/n4, the UE may determine the first PRB set and the second PRB set as follows:
In an embodiment, the first PRB set may include even-numbered PRGs, and the second PRB set may include odd-numbered PRGs. The index of PRGs may start from 0 in ascending order in the frequency domain. The UE may exclude partial PRGs among the first PRB set and the second PRB set. As used herein, partial PRGs may refer to partial PRGs which do not include two RBs in case that the PRG granularity is n2, or PRGs which do not include four RBs in case that the PRG granularity is n4. For example, the above-described embodiment may relate to a method in which the first PRB set and the second PRB set are generated first regardless of whether there are partial PRGs or not, and the partial PRGs are excluded from the first PRB set and the second PRB set.
In an embodiment, the first PRB set may include even-numbered PRGs, and the second PRB set may include odd-numbered PRGs. The index of PRGs may start from 0 in ascending order in the frequency domain. The UE may exclude partial PRGs among the first PRB set and the second PRB set. The partial PRGs may be exempted from indexing. The example, the UE may index PRGs other than partial PRGs, and may determine the first PRB set and the second PRB set according to the index. The exempted partial PRGs may be the last PRG of the first DL subband (DL subband in a low position in the frequency domain), or the first PRG of the second DL subband (DL subband in a high position in the frequency domain).

### [Embodiment: Processing Time Relaxing and UE Capability Reporting]

An embodiment of the disclosure may relate to a case in which bundleSize=wideband is configured for the UE. According to the prior art, in case that bundleSize=wideband is indicated to the UE, the UE may expect that scheduled RBs may be consecutive in the frequency domain. For example, in case that RBs that are nonconsecutive in the frequency domain are scheduled, the UE may ignore the scheduling. In an embodiment of the disclosure, in case that RBs that are nonconsecutive in the frequency domain are scheduled, some scheduling may be allowed. The allowable scheduling may include at least one of the following. Obviously, the following example is not limitative.

As the first scheduling, in case that a PDSCH is scheduled across two DL subbands in an SBFD symbol, and RBs included in the PDSCH scheduled for each DL subband are consecutive in the frequency domain (for example, RBs included in the PDSCH scheduled for the first subband are consecutive in the frequency domain, and RBs included in the PDSCH scheduled for the second subband are consecutive in the frequency domain), the UE may determine that PDSCH scheduling is allowed.

As the second scheduling, in case that a PDSCH is scheduled, and to RBs are consecutive in the frequency domain (for example, first RBs included in the scheduled PDSCH are consecutive in the frequency domain, remaining second RBs are consecutive in the frequency domain, and the first RBs and the second RBs are nonconsecutive with each other in the frequency domain), the UE may determine that PDSCH scheduling is allowed.

In the disclosure, whether the first scheduling may be allowed, the second scheduling may be allowed, or both the first scheduling and the second scheduling may be allowed may be determined according to the UE capability report and the gNB's upper layer signal configurations.

For example, in case that the first scheduling is indicated, the UE may report, to the gNB, whether PDSCH reception may be possible by using one of piece information among the UE capability report. In case that the first scheduling is indicated, and the UE reports that PDSCH reception is impossible, the UE may not expect that a PDSCH may be scheduled according to the first scheduling, or may receive no PDSCH scheduled by the first scheduling.

For example, in case that the second scheduling is indicated, the UE may report, to the gNB, whether PDSCH reception may be possible by using one of piece information among the UE capability report. In case that the second scheduling is indicated, and the UE reports that PDSCH reception is impossible, the UE may not expect that a PDSCH may be scheduled according to the second scheduling, or may receive no PDSCH scheduled by the second scheduling.

In case that the first or second scheduling is indicated to the UE, and the UE reports to the gNB that PDSCH reception is possible, the UE may receive a separate upper layer signal from the gNB. The upper layer signal may configure whether the first or second scheduling is allowed or not. For example, even if the UE reports that PDSCH reception is possible in case that the first scheduling is indicated, the upper layer signal from the gNB may determine whether the first scheduling is allowed or not to the UE.

The UE may transmit a UE capability report to the gNB to indicate whether the first scheduling and/or the second scheduling is possible or not. The UE may transmit an additional processing time necessary during the first scheduling and/or the second scheduling. The additional processing time may be referred to as d4.

The UE may be configured by the gNB the first scheduling and/or the second scheduling can be indicated. The UE may receive a configuration indicating that the first scheduling and/or the second scheduling can be indicated from the gNB. In case that the UE is scheduled according to the first scheduling and/or the second scheduling, the UE may determine a relaxed processing time, based on the reported d4 value.

The UE may receive configurations regarding the d4 value to be used, and regarding whether the first scheduling and/or the second scheduling can be indicated or not, from the gNB. The UE may receive configurations regarding the d4 value and configurations indicating that the first scheduling and/or the second scheduling can be indicated, from the gNB. In case that the UE is scheduled according to the first scheduling and/or the second scheduling, the UE may determine a relaxed processing time, based on the configured d4 value. For example, the d4 value configured for the UE by the gNB may be larger than or equal to the d4 value reported by the UE through capability reporting. For example, the UE may report the d4 value as UE capability, but the gNB may configure a value larger than or equal to the d4 value in order to reduce the UE's power consumption, or to facilitate the UE's processing.

The gNB may configure the d4 value to be used for the first scheduling and/or the second scheduling, for the UE. In case that the d4 value configured for the UE is larger than or equal to the d4 value of the UE capability value, the UE may determine that the scheduling is possible, and may determine a relaxed processing time, based on the configured d4 value. In case that the d4 value configured for the UE is smaller than the d4 value of the UE capability value, the UE may determine that the scheduling is impossible, may receive no PDSCH scheduled by the scheduling, and may ignore or discard the scheduling information.

The UE may determine a relaxed processing time to which an additional processing time is applied. In case that a PUSCH or a PUCCH including a HARQ-ACK is received within the relaxed processing time since PDSCH reception by the UE, the HARQ-ACK may not include the PDSCH's valid HARQ-ACK.

The relaxed processing time may be expressed as follows:

$${T}_{proc , 1} = ( {N}_{1} + {d}_{1 , 1} + {d}_{2} + {d}_{3} + {d}_{4} ) ( 2048 + 144 ) \cdot κ {2}^{- μ} \cdot {T}_{C} + {T}_{ext}$$

where regarding N₁, d_{1,1}, d₂, d₃. K, μ, T_{C}, Tₑₓₜ, 3GPP standard documents TS38.211 and TS38.214 v18.1.0 may be referenced.

In an embodiment of the disclosure, the UE may report d4 to the gNB in at least one of the following methods. Obviously, the following example is not limitative.
In a method, the UE may report the d₄ value, based on the subcarrier spacing (μ). For example, the UE may report the first d4 value in case that μ=0, may report the second d4 value in case that μ=1, and may report the third d4 value in case that μ=2. The gNB and the UE may determine the relaxed processing time by using the d4 value corresponding to the subcarrier spacing (μ).
In a method, the UE may report the d₄ value with regard to each possible scheduling method. For example, in case that first scheduling is possible, the UE may report the d₄ value corresponding thereto, and in case that second scheduling is possible, the UE may report the d₄ value corresponding thereto. In another method, the UE may report a d₄ value common to possible scheduling methods. For example, the common d₄ value may be applied to all scheduling methods.
In a method, the UE may report the d₄ value with regard to each additional DMRS symbol number. For example, the UE may report the d₄ value in case that there is no additional DMRS symbol (only front-loaded DMRS symbols exist), and may report the d₄ value in case that there is one additional DMRS symbol. In another method, the UE may report the d₄ value in case that there is no additional DMRS symbol (only front-loaded DMRS symbols exist), and the gNB and the UE may use a value determined by scaling the d₄ value as the d₄ value in the case of a PDSCH including additional DMRS symbols. For example, if as many symbols as i are included as additional DMRS symbols, the d₄*(i+1) value may be used as the d₄ value.

### [Embodiment: Transport Block Size Determination]

FIG. 17 illustrates a PDSCH scheduling method in a wireless communication system according to an embodiment of the disclosure (e.g., (a), (b), and (c) as illustrated in FIG. 17).

The UE may have a PDSCH scheduled by the gNB. A PDSCH scheduling method may be described in the disclosure with reference to FIG. 17 (e.g., (a), (b), and (c) as illustrated in FIG. 17).
PDSCH repeated reception. The DCI format may instruct the UE to receive PDSCH repetitions in multiple slots. The PDSCH repetitions may include the same transport block (TB). In each slot, PDSCH repetition may occupy the same symbol. For example, PDSCH repetitions may be received through five symbols ranging from the third symbol of each slot to the seventh symbol of each slot, among the multiple slots.
Multi-PDSCH scheduling. The DCI format may instruct the UE to receive multiple PDSCHs. The multiple PDSCHs may include different TBs, respectively, and may be received in different symbols.
SPS PDSCH scheduling. The activation DCI format may instruct the UE to receive an SPS PDSCH in each periodicity. The periodicity may be configured in terms of slots by an upper layer signal. The SPS PDSCH received in each periodicity may include a different TB.

The above-described DCI format that schedules PDSCH repeated reception, the DCI format that schedules multiple PDSCHs, or the (activation) DCI format that indicates SPS activation may indicate the PDSCH's frequency allocation information. RBs included in the PDSCH may be determined according to the frequency allocation information. In case that one of multiple slots is configured by downlink symbols other than SBFD symbols, all RBs determined according to the frequency allocation information may be used to for PDSCH repetition in the corresponding slot. In case that one of multiple slots is configured by SBFD symbols, a PDSCH may be received in RBs in which downlink reception is possible, among RBs determined according to the frequency allocation information, in the corresponding slot. For example, a different number of RBs may be used to receive a PDSCH in each slot.

A PDSCH corresponding to the above-described DCI format that schedules PDSCH repeated reception, the DCI format that schedules multiple PDSCHs, or the (activation) DCI format that indicates SPS activation may have the same MCS configured therefor. For example, the UE may receive PDSCHs, based on the same MCS.

In case that the above-described DCI format that schedules PDSCH repeated reception, the DCI format that schedules multiple PDSCHs, or the (activation) DCI format that indicates SPS activation indicates the PDSCH's frequency allocation information, the UE may determine the frequency allocation information, based on the frequency domain resource allocation (FDRA) field of the DCI format. More specifically, the FDRA field's length may be determined by at least one of the following methods. Obviously, the following example is not limitative.
In the first method, the FDRA field's length may be determined based on RBs included in the DL bandwidth part. In this case, RBs scheduled in an SBFD symbol may be RBs included in the DL subband among RBs which the UE has acquired by interpreting the FDRA field based on RBs included in the DL bandwidth part.
In the second method, the FDRA field's length may be determined based on RBs included in the DL bandwidth part. In this case, RBs scheduled in an SBFD symbol may be RBs which the UE has acquired by interpreting the FDRA field based on RBs included in the DL bandwidth part. The UE may assume that the FDRA field's length is larger than or equal to bits necessary to interpret the FDRA field based on RBs included in the DL subband, based on RBs included in the DL bandwidth part. In addition, if the FDRA field's length is smaller than bits necessary to interpret the FDRA field based on RBs included in the DL subband, based on RBs included in the DL bandwidth part, the UE may make necessary bits by attaching “0” to the FDRA field, and then interpret the same. Alternatively, if the FDRA field's length is larger than bits necessary to interpret the FDRA field based on RBs included in the DL subband, based on RBs included in the DL bandwidth part, the UE may interpret the FDRA field by using some bits (least significant bits (LSB)) corresponding to the bits necessary in the FDRA field.
In the third method, it may be determined that the larger value between the FDRA field's length based on RBs included in the DL bandwidth part and the FDRA field's length based on RBs included in the DL subband is the FDRA field's length. In this case, RBs scheduled in an SBFD symbol may be RBs which the UE has acquired by interpreting the FDRA field based on RBs included in the DL subband. RBs scheduled in a non-SBFD symbol may be RBs which the UE has acquired by interpreting the FDRA field based on RBs included in the DL bandwidth part. The UE may interpret the FDRA field by using some bits (LSB) corresponding to the bits necessary in the FDRA field.

According to the first to third methods, the number of RBs allocated to a PDSCH in an SBFD symbol and the number of RBs allocated to a PDSCH in a non-SBFD symbol may differ from each other.

The TB's length may be determined through the process in Table 21. In the table, n_{PRB} may be the number of RBs allocated for PDSCH reception to the UE. As described above, the number of RBs allocated for the UE's PDSCH reception may differ with regard to each slot. Therefore, the UE may need to determine the number of RBs allocated for PDSCH reception in order to determine the TB's length. Methods therefor may be as follows:

TABLE 21
1) The UE may first determine the number of REs (N_{RE}) within the slot.
- A UE first determines the number of REs allocated for PDSCH within a PRB (N′_{RE}) by N′_{RE} =
N_{sc}^{RB} · N_{symb}^{sh} − N_{DMRS}^{PRB} − Nₒₕ^{PRB}, where N_{sc}^{RB} = 12 is the number of subcarriers in a physical
resource block, N_{symb}^{sh} is the number of symbols of the PDSCH allocation within the slot, N_{DMRS}^{PRB}
is the number of REs for DM-RS per PRB in the scheduled duration including the overhead of
the DM-RS CDM groups without data, as indicated by DCI format 1_1 or as described for
format 1_0 in clause 5.1.6.2, and Nₒₕ^{PRB} is the overhead configured by higher layer parameter
xOverhead in PDSCH-ServingCellConfig. If the xOverhead in PDSCH-ServingCellconfig is not
configured (a value from 0, 6, 12, or 18), the Nₒₕ^{PRB} is set to 0. If the PDSCH is scheduled by
PDCCH with a CRC scrambled by SI-RNTI, RA-RNTI or P-RNTI, Nₒₕ^{PRB} is assumed to be 0.
- A UE determines the total number of REs allocated for PDSCH ( N_{RE} ) by N_{RE} =
min(156, N′_{RE}) · n_{PRB}, where n_{PRB} is the total number of allocated PRBs for the UE.

In the first method, the UE may determine the n_{PRB} based on the largest value among the number of RBs of respective PDSCHs scheduled by one DCI format. More specifically, in case that PDSCHs scheduled by one DCI format are received in a slot configured by SBFD symbols and in a slot configured by non-SBFD symbols, the UE may determine the number of RBs included in the PDSCH in the slot configured by non-SBFD symbols. The UE may consider or determine that the number of the RBs is the n_{PRB}.

In the second method, the UE may determine the n_{PRB} based on the smallest value among the number of RBs of respective PDSCHs scheduled by one DCI format. More specifically, in case that PDSCHs scheduled by one DCI format are received in a slot configured by SBFD symbols and in a slot configured by non-SBFD symbols, the UE may determine the number of RBs included in the PDSCH in the slot configured by SBFD symbols. The UE may consider or determine that the number of the RBs is the n_{PRB}.

In the third method, the UE may determine the n_{PRB} based on the foremost in the time domain (or first) PDSCH among PDSCHs scheduled by one DCI format. More specifically, in case that PDSCHs scheduled by one DCI format are received in a slot configured by SBFD symbols and in a slot configured by non-SBFD symbols, the UE may determine the foremost in the time domain (or first) PDSCH, and may consider or determine that the number of the RBs included in the PDSCH is the n_{PRB}.

In the fourth method, the UE may have a symbol type indicated or configured by the gNB so as to be used to determine the n_{PRB}. More specifically, in case that PDSCHs scheduled by one DCI format are received in a slot configured by SBFD symbols and in a slot configured by non-SBFD symbols, and in case that the symbol type indicted or configured for the UE is an SBFD symbol, the UE may determine the number of RBs included in the PDSCH in the slot configured by SBFD symbols. The UE may consider or determine that the number of the RBs is the n_{PRB}. In case that the symbol type indicted or configured for the UE is not an SBFD symbol, the UE may determine the number of RBs included in the PDSCH in the slot configured by non-SBFD symbols. The UE may consider or determine that the number of the RBs is the n_{PRB}.

The symbol type may be indicated by a DCI format that schedules a PDSCH. In an embodiment, the DCI format may include a one-bit field. If the one bit is a first value (for example, “0”), the TB's length may be determined based on non-SBFD symbols. If the one bit is a second value (for example, “1”), the TB's length may be determined based on SBFD symbols. In an embodiment, one symbol type corresponding to each row of the TDRA field of the DCI format that schedules a PDSCH may be configured. For example, the first row may determine the TB's length based on SBFD symbols, and the second row may determine the TB's length based on non-SBFD symbols. In an embodiment, one symbol type corresponding to a HARQ process number corresponding to a PDSCH may be configured. For example, in the case of a PDSCH corresponding to a specific HARQ process number, the TB's length may be determined based on SBFD symbols. In the case of another PDSCH corresponding to a another specific HARQ process number, the TB's length may be determined based on non-SBFD symbols.

In the fifth method, the UE may determine the n_{PRB} according to the symbol number of a symbol type in which PDSCHs scheduled by one DCI format overlap. For example, it may be assumed that the number of SBFD symbols in which PDSCHs scheduled by one DCI format overlap is Nsymb, SBFD, and the number of non-SBFD symbols in which PDSCHs scheduled by one DCI format overlap is Nsymb, non-SBFD. If Nsymb, SBFD>Nsymb,non-SBFD, the UE may determine the number of RBs included in the PDSCH in the slot configured by SBFD symbols. If Nsymb, SBFD<Nsymb,non-SBFD, the UE may determine the number of RBs included in the PDSCH in the slot configured by non-SBFD symbols. If Nsymb, SBFD=Nsymb, non-SBFD, the UE may determine the nPRB based on the above-described methods.

The UE may determine the nPRB according to the slot number of a symbol type in which PDSCHs scheduled by one DCI format overlap. For example, it may be assumed that the number of SBFD slots in which PDSCHs scheduled by one DCI format overlap is Nslot, SBFD, and the number of non-SBFD slots in which PDSCHs scheduled by one DCI format overlap is Nslot, non-SBFD. If Nslot, SBFD>Nslot,non-SBFD, the UE may determine the number of RBs included in the PDSCH in the slot configured by SBFD symbols. If Nslot, SBFD<Nslot,non-SBFD, the UE may determine the number of RBs included in the PDSCH in the slot configured by non-SBFD symbols. If Nslot, SBFD=Nslot,non-SBFD, the UE may determine the nPRB based on the above-described methods. The number of slots may be interpreted as the number of PDSCH repetition occasions.

In the sixth method, the UE may determine the nPRB according to the ratio of symbol numbers of a symbol type in which PDSCHs scheduled by one DCI format overlap. For example, it may be assumed that the number of SBFD symbols in which PDSCHs scheduled by one DCI format overlap is Nsymb,SBFD, and the number of RBs included in PDSCHs in SBFD symbols is NRB,SBFD. It may be assumed that the number of non-SBFD symbols in which PDSCHs scheduled by one DCI format overlap is Nsymb,non-SBFD, and the number of RBs included in PDSCHs in non-SBFD symbols is NRB,non-SBFD. The nPRB may be determined as in Equation 2:

$$nPRB = ( Nsymb , SBFD * NRB , SBFD + Nsymb , non - SBFD * , non - SBFD ) / ( Nsymb , SBFD + Nsymb , non - SBFD ) \qquad [ Equation 2 ]$$

where, in case that the nPRB is not an integer, flooring, ceiling, or rounding may be applied thereto.

The UE may determine the nPRB according to the ratio of slot numbers of a symbol type in which PDSCHs scheduled by one DCI format overlap. For example, it may be assumed that the number of SBFD slots in which PDSCHs scheduled by one DCI format overlap is Nslot,SBFD, and the number of RBs included in PDSCHs in SBFD slots is NRB,SBFD. It may be assumed that the number of non-SBFD slots in which PDSCHs scheduled by one DCI format overlap is Nslot,non-SBFD, and the number of RBs included in PDSCHs in non-SBFD symbols is NRB,non-SBFD. The nPRB may be determined as in Equation 3:

$$nPRB = ( Nslot , SBFD * NRB , SBFD + Nslot , nonSBFD * , NRB , non - SBFD ) / ( Nslot , SBFD + Nslot , non - SBFD ) \qquad [ Equation 3 ]$$

wherein, in case that the nPRB is not an integer, flooring, ceiling, or rounding may be applied thereto.

In the seventh method, in the case of a DCI format that schedules PDSCH repetition reception, the TB's length may be determined by one of the first to sixth methods described above. In the case of a DCI format that schedules multiple PDSCHs or an (activation) DCI format that indicates SPS activation, the TB's length may be determined with regard to each PDSCH.

More specifically, in case that a DCI format schedules multiple PDSCHs, the multiple PDSCHs, may include different TBs, respectively. Therefore, the TBs corresponding to respective PDSCHs may have different TB lengths determined therefor. For example, in case of determining the length of a TB corresponding to a PDSCH in a slot configured by SBFD symbols, the TB's length may be determined based on the number of RBs included in the PDSCH in the slot configured by SBFD symbols. In case of determining the length of a TB corresponding to a PDSCH in a slot configured by non-SBFD symbols, the TB's length may be determined based on the number of RBs included in the PDSCH in the slot configured by non-SBFD symbols.

More specifically, in case that a DCI format schedules an SPS PDSCH, the SPS PDSCH may include a different TB in each periodicity. Therefore, TBs corresponding to the SPS PDSCH in each periodicity may have different TB lengths determined therefor. For example, in case of determining the length of a TB corresponding to the SPS PDSCH in a slot configured by SBFD symbols, the TB's length may be determined based on the number of RBs included in the SPS PDSCH in the slot configured by SBFD symbols. In case of determining the length of a TB corresponding to the SPS PDSCH in a slot configured by non-SBFD symbols, the TB's length may be determined based on the number of RBs included in the SPS PDSCH in the slot configured by non-SBFD symbols.

In the eighth method, in the case of a DCI format that schedules PDSCH repetition reception or an (activation) DCI format that indicates SPS activation, the TB's length may be determined by one of the first to sixth methods described above. In the case of a DCI format that schedules multiple PDSCHs, the TB's length may be determined with regard to each PDSCH as described in the seventh method.

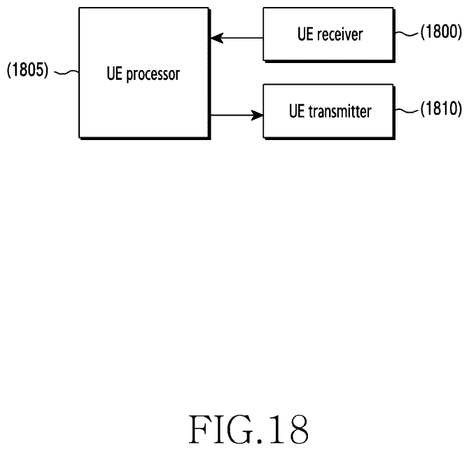

FIG. 18 illustrates a structure of a UE in a wireless communication system according to an embodiment of the disclosure.

Referring to FIG. 18, the UE may include a transceiver, which refers to a UE receiver 1800 and a UE transmitter 1810 as a whole, a memory (not illustrated), and a UE processor 1805 (or UE controller or processor). The UE transceiver 1800 and 1810, the memory, and the UE processor 1805 may operate according to the above-described communication methods of the UE. The UE processor 1805 may control operations of the UE according to not only the above-described respective embodiments but also combinations of at least one thereof. Components of the UE are not limited to the above-described example. For example, the UE may include a larger or smaller number of components than the above-described components. Furthermore, the UE processor 1805, the UE transmitter 1810, the UE receiver 1800, and the memory may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include a storage medium such as a ROM, a RAM, a hard disk, a CD-ROM, or a DVD, or a combination of storage media. In addition, the memory may include multiple memories, and the memory may store instructions for performing the above-described communication methods.

Furthermore, the UE processor 1805 may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

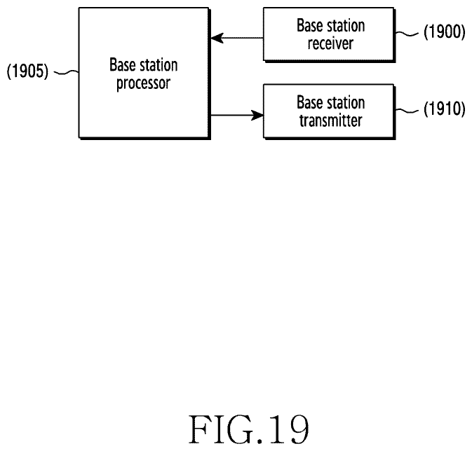

FIG. 19 illustrates a structure of a base station in a wireless communication system according to an embodiment of the disclosure.

Referring to FIG. 19, the base station may include a transceiver, which refers to a base station receiver 1900 and a base station transmitter 1910 as a whole, a memory (not illustrated), and a base station processor 1905 (or base station controller or processor). The base station transceiver 1900 and 1910, the memory, and the base station processor 1905 may operate according to the above-described communication methods of the base station. The base station processor 1905 may control operations of the base station according to not only the above-described respective embodiments but also combinations of at least one thereof. However, components of the base station are not limited to the above-described example. For example, the base station may include a larger or smaller number of components than the above-described components. Furthermore, the base station receiver 1900, the base station transmitter 1910, the memory, and the base station processor 1905 may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include a storage medium such as a ROM, a RAM, a hard disk, a CD-ROM, or a DVD, or a combination of storage media. In addition, the memory may include multiple memories, and the memory may store instructions for performing the above-described communication methods.

The base station processor 1905 may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it may be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, configuration information on a precoder resource block group (PRG) granularity;
receiving, from the base station, downlink control information (DCI) including information indicating a size of a physical resource block (PRB) bundling; and
identifying the PRG granularity based on the information and at least one downlink (DL) subband.

2. The method of claim 1, wherein the PRG granularity is identified based on whether a number of scheduled PRBs is larger than half of a size of one of the at least one DL subband.

3. The method of claim 1, wherein the configuration information includes first information indicating a dynamic bundling and second information indicating a set of bundling sizes.

4. The method of claim 3, wherein the information indicating the size of the PRB bundling includes a field set to a value of one.

5. The method of claim 3, wherein the set of the bundling sizes is configured based on two values, and
wherein the two values include a first set of n4 and wideband or a second set of n2 and wideband.

6. A method performed by a base station in a wireless communication system, the method comprising:
transmitting, to a terminal, configuration information on a precoder resource block group (PRG) granularity; and
transmitting, to the terminal, downlink control information (DCI) including information indicating a size of a physical resource block (PRB) bundling,
wherein the PRG granularity is identified based on the information and at least one downlink (DL) subband.

7. The method of claim 6, wherein the PRG granularity is based on whether a number of scheduled PRBs is larger than half of a size of one of the at least one DL subband.

8. The method of claim 6, wherein the configuration information includes first information indicating a dynamic bundling and second information indicating a set of bundling sizes.

9. The method of claim 8, wherein the information indicating the size of the PRB bundling includes a field set to a value of one.

10. The method of claim 8, wherein the set of the bundling sizes is configured based on two values, and
wherein the two values include a first set of n4 and wideband or a second set of n2 and wideband.

11. A terminal in a wireless communication system, the terminal comprising:
a transceiver; and
at least one processor coupled with the transceiver and configured to:
receive, from a base station, configuration information on a precoder resource block group (PRG) granularity,
receive, from the base station, information indicating a size of a physical resource block (PRB) bundling, and
identify the PRG granularity based on the information and at least one downlink (DL) subband.

12. The terminal of claim 11, wherein the PRG granularity is identified based on whether a number of scheduled PRBs is larger than half of a size of one of the at least one DL subband.

13. The terminal of claim 11, wherein the configuration information includes first information indicating a dynamic bundling and second information indicating a set of bundling sizes.

14. The terminal of claim 13, wherein the information indicating the size of the PRB bundling includes a field set to a value of one.

15. The terminal of claim 13, wherein the set of the bundling sizes is configured based on two values, and
wherein the two values include a first set of n4 and wideband, or a second set of n2 and wideband.

16. A base station in a wireless communication system, the base station comprising:
a transceiver; and
at least one processor coupled with the transceiver and configured to:
transmit, to a terminal, configuration information on a precoder resource block group (PRG) granularity, and
transmit, to the terminal, downlink control information (DCI) including information indicating a size of a physical resource block (PRB) bundling,
wherein the PRG granularity is identified based on the information and at least one downlink (DL) subband.

17. The base station of claim 16, wherein the PRG granularity is based on whether a number of scheduled PRBs is larger than half of a size of one of the at least one DL subband.

18. The base station of claim 16, wherein the configuration information includes first information indicating a dynamic bundling and second information indicating a set of bundling sizes.

19. The base station of claim 16, wherein the information indicating the size of the PRB bundling includes a field set to a value of one.

20. The base station of claim 16, wherein a set of bundling sizes is configured based on with two values, and
wherein the two values include a first set of n4 and wideband, or a second set of n2 and wideband.
